(19) United States
(12) Patent Application Publication
(10) Pub. No.: US 2008/0244486 A1
(43) Pub. Date: Oct. 2, 2008

(54) INTEGRATED CIRCUIT GENERATING DEVICE, METHOD THEREFOR, AND PROGRAM

(75) Inventor: Hideki KAZAMA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 12/019,249

(22) Filed: Jan. 24, 2008

(30) Foreign Application Priority Data
Mar. 28, 2007 (JP) 2007-085010

(51) Int. Cl. G06F 17/50

(52) U.S. Cl. 716/6

(57) ABSTRACT

An integrated-circuit generating device for generating an integrated circuit including an adjusting mechanism for adjusting timings of values sequentially outputted from circuits operating in parallel. The device includes a test-circuit storing section for storing test circuit information for validating the integrated circuit, a circuit-information storing section for storing circuit information, a configuration-information-output-circuit storing section for storing operation information of a circuit for compiling configuration information of the adjusting mechanism while the configuration information is generated, a configuration-information generating section for generating and compiling the configuration information of the adjusting mechanism by using the circuit information of the test circuit, the circuit information of the integrated circuit, and the operation information of the circuit, each of which stored in the test-circuit storing section, the circuit-information storing section, and the configuration-information-output-circuit storing section, and a circuit generating device for generating the circuit information of an optimal adjusting mechanism based on the adjusting-mechanism configuration information by the configuration-information generating section.

### BACKGROUND OF THE INVENTION

1. Field of the Invention

The present invention relates to an integrated-circuit generating device for generating an integrated circuit including an adjusting mechanism, such as a synchronization mechanism for making timings coincident with values sequentially outputted from a plurality of circuits operating in parallel, a parallel access mechanism for adjusting a timing for accessing in parallel from a plurality of circuits, or the like. The present invention relates also to a method therefor, and a program.

2. Description of the Related Art

Integrated circuits in which a plurality of circuits for sequentially outputting a value exist may require a synchronization mechanism for making timings of values sequentially outputted from each of the circuits operating in parallel coincident.

FIG. 1 is a block diagram showing a configuration example of a typical synchronization-mechanism-circuit generating device.

The synchronization-mechanism-circuit generating device in FIG. 1 includes a synchronization-mechanism-configuration storing section 1, a synchronization-mechanism generating device 2, a synchronization-mechanism-circuit-information storing section 3, and a display device 4.

In the synchronization-mechanism-circuit generating device, when a synchronization mechanism for making timings of values sequentially outputted from each circuit operative in parallel coincide is generated, it is necessary to provide synchronization-mechanism configuration information stored in the synchronization-mechanism-configuration storing section 1 to the synchronization-mechanism generating device 2, as shown in FIG. 1.

FIG. 2 is a block diagram showing a configuration example of a typical parallel-access-mechanism-circuit generating device.

The parallel-access-mechanism-circuit generating device of FIG. 2 includes a parallel-access-mechanism-configuration storing section 5, a parallel-access-mechanism generating device 6, a parallel-access-mechanism-circuit-information storing section 7, and a display device 8.

Also in the parallel-access-mechanism-circuit generating device, when a parallel access mechanism is generated, as shown in FIG. 2, it may be necessary to provide parallel-access-mechanism configuration information stored in the parallel-access-mechanism-configuration storing section 5 to the parallel-access-mechanism generating device 6.

### SUMMARY OF THE INVENTION

However, as the integrated circuit becomes large-scale, it gradually becomes difficult and takes a time to appropriately determine the synchronization-mechanism configuration information and the parallel-access-mechanism configuration information. Further, it is necessary to re-determine configuration information of a timing adjusting mechanism of the synchronization mechanism or the parallel access mechanism, each time a specification of the circuit changes.

Thus, in the synchronization-mechanism-circuit generating device and the parallel-access-mechanism-circuit generating device, there is a disadvantage in that a period of designing the adjusting mechanisms of the synchronization mechanism and the parallel access mechanism increases.

According to embodiments of the present invention, there is provided an integrated-circuit generating device capable of generating an adjusting mechanism without inputting a specification, easily re-generating the adjusting mechanism such as an optimal synchronization mechanism, parallel access mechanism or the like even when a timing specification of a circuit changes, and shortening a period of designing the adjusting mechanism such as a synchronization mechanism, a parallel access mechanism or the like. There is also provided a method therefor and a program.

According to a first aspect of the present invention, there is provided an integrated-circuit generating device for generating an integrated circuit including an adjusting mechanism for adjusting timings of values sequentially outputted from circuits operative in parallel. The device includes a test-circuit storing section for storing test circuit information for validating the integrated circuit; a circuit-information storing section for storing circuit information; a configuration-information-output-circuit storing section for storing operation information of a circuit for compiling configuration information of the adjusting mechanism while the configuration information is generated; a configuration-information generating section for generating and compiling the configuration information of the adjusting mechanism by using the circuit information of the test circuit, the circuit information of the integrated circuit, and operation information of the circuit, each of which stored in the test-circuit storing section, the circuit-information storing section, and the configuration-information-output-circuit storing section, and a circuit generating device for generating the circuit information of an optimal adjusting mechanism based on the adjusting-mechanism configuration information by the configuration-information generating section.

According to a second aspect of the present invention, there is provided an integrated-circuit generating method for generating an integrated circuit including an adjusting mechanism for adjusting timings of values sequentially outputted from circuits operative in parallel, including a configuration-information generating step for generating and compiling configuration information of the adjusting mechanism by using test circuit information for validating the integrated circuit, circuit information of the integrated circuit, and operation information of a configuration-information output circuit, and a circuit generating step for generating the circuit information of an optimal adjusting mechanism based on the adjusting-mechanism configuration information by the configuration-information generating step.

According to a third aspect of the present invention, there is provided a program for allowing a computer to execute a process for generating an integrated circuit including an adjusting mechanism for adjusting timings of values sequentially outputted from circuits operative in parallel, the process includes a configuration-information generating process for generating and compiling configuration information of the adjusting mechanism by using test circuit information for validating the integrated circuit, circuit information of the integrated circuit, and operation information of a configuration-information output circuit, and a circuit generating process for generating the circuit information of an optimal adjusting mechanism based on the adjusting-mechanism configuration information by the configuration-information generating step.

According to embodiments of the present invention, in the configuration-information generating section, the circuit information of the test circuit, the circuit information of the integrated circuit, and the operation information of the circuit, each of which stored in the test-circuit storing section, the circuit-information storing section, and the configuration-information-output-circuit storing section are used to generate and compile the configuration information of the adjusting mechanism. The information is used by the circuit generating device.

Subsequently, in the circuit generating device, the circuit information of the optimal adjusting mechanism is generated based on the adjusting-mechanism configuration information by the configuration-information generating section.

### BRIEF DESCRIPTION OF THE DRAWINGS

FIG. 1 is a block diagram showing a configuration example of a typical synchronization-mechanism-circuit generating device;

FIG. 2 is a block diagram showing a configuration example of a typical parallel-access-mechanism-circuit generating device;

FIG. 3 is a diagram showing a configuration example of an integrated-circuit generating device according to an embodiment of the present invention;

FIG. 4 is a diagram for describing a synchronization mechanism circuit;

FIG. 5 is a chart showing one example of a timing chart in a case where the synchronization mechanism circuit is operated;

FIG. 6 is a flowchart for describing an operation in which a simulation is performed in a simulation device to generate synchronization-mechanism configuration information;

FIG. 7 is a flowchart for describing an operation for generating a synchronization mechanism by a synchronization-mechanism generating device;

FIG. 8 is a diagram showing an example of an integrated circuit realized by the embodiment;

FIG. 9 is a timing chart showing an operation example of a fourth circuit (synchronization mechanism circuit) in FIG. 8;

FIG. 10 is a diagram showing information to be inputted to an output-synchronization-mechanism generating device of a parallel process according to the embodiment;

FIG. 11 is a diagram showing one example of synchronization-mechanism-configuration information according to the embodiment;

FIG. 12 is a table showing data inputs and data outputs at each time, in which artificially ideal behavior of the synchronization mechanism circuit is performed;

FIG. 13 is a diagram showing a first configuration example of the synchronization mechanism circuit generated from the synchronization-mechanism configuration information shown in FIG. 11;

FIG. 14 is a diagram showing a second configuration example of the synchronization mechanism circuit generated from the synchronization-mechanism configuration information shown in FIG. 11;

FIG. 15 is a flowchart for describing a procedure for generating the synchronization mechanism circuit based on a circuit scale;

FIG. 16 shows a flowchart for describing one example of an operation for outputting configuration information of the synchronization mechanism;

FIG. 17 is a table showing values of output, counter[1] counter [2], queue Q1, and queue Q2 at each time when a signal shown in FIG. 9 is inputted, as one example of the operation;

FIG. 18 is a diagram showing an example of a configuration candidate 1;

FIG. 19 is a diagram showing an example of a configuration candidate 2;

FIG. 20 is a table showing an example of an operation when the signal shown in FIG. 9 is inputted to a circuit of FIG. 18;

FIG. 21 is a table showing an example of an operation when the signal shown in FIG. 9 is inputted to a circuit of FIG. 19;

FIG. 22 is a diagram showing a configuration example of an integrated-circuit generating device according to a second embodiment of the present invention;

FIG. 23 is a diagram showing a configuration example of an integrated-circuit generating device according to a third embodiment of the present invention;

FIG. 24 is a diagram for describing a parallel-access mechanism circuit;

FIG. 25 is a chart showing one example of a timing chart in a case where the parallel-access mechanism circuit is operated;

FIG. 26 is a flowchart for describing an operation in which a simulation is performed in a simulation device to generate parallel-access-mechanism configuration information;

FIG. 27 is a flowchart for describing an operation for generating a parallel access mechanism by a circuit generating device;

FIG. 28 is a table showing information supplied to a configuration-information storing section;

FIG. 29 is a diagram showing an example of an integrated circuit realized by the embodiment;

FIG. 30 is a diagram showing information to be inputted into a circuit generating device of a parallel process according to the embodiment;

FIG. 31 is a flowchart showing an example of an operation for generating of a parallel-access mechanism circuit performed in the circuit generating device;

FIG. 32 is a diagram showing a first configuration example of a generated parallel-access mechanism circuit;

FIG. 33 is a diagram showing a second configuration example of a generated parallel-access mechanism circuit;

FIG. 34 is a diagram showing an SRAM-base first configuration example of a synchronization mechanism circuit; and

FIG. 35 is a diagram showing an SRAM-base second configuration example of the synchronization mechanism circuit.

### DETAILED DESCRIPTION OF THE EMBODIMENTS

Hereinafter, with reference to the accompanying drawings, an embodiment of the present invention is described.

### First Embodiment

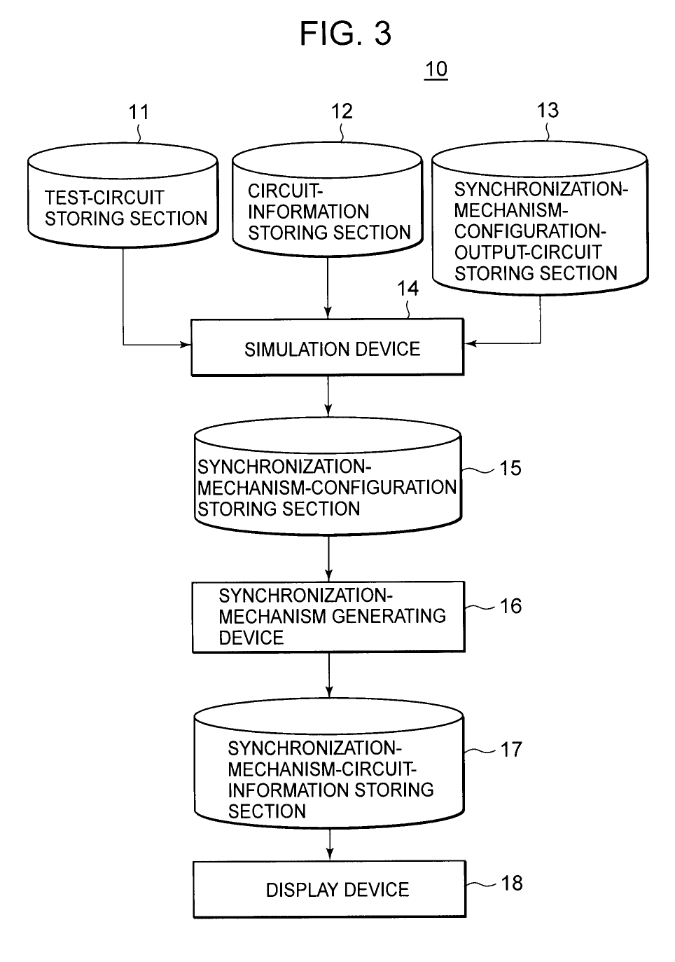

FIG. 3 is a diagram showing a configuration example of an integrated-circuit generating device according to a first embodiment of the present invention.

As shown in FIG. 3, an integrated-circuit generating device 10 includes a test-circuit storing section 11, a circuit-information storing section 12, a synchronization-mechanism-configuration-output-circuit storing section 13, a simulation device 14 as a configuration-information generating device, a synchronization-mechanism-configuration storing section 15, a synchronization-mechanism generating device 16, a synchronization-mechanism-circuit-information storing section 17, and a display device 18.

The integrated-circuit generating device 10 having such a structure is configured to be a device capable of generating a synchronization mechanism which is one of the adjusting mechanisms, without inputting configuration information of the synchronization mechanism.

The test-circuit storing section 11, the circuit-information storing section 12, the synchronization-mechanism-configuration-output-circuit storing section 13, the synchronization-mechanism-configuration storing section 15, and the synchronization-mechanism-circuit-information storing section 17 are configured by a memory, for example.

The test-circuit storing section 11, the circuit-information storing section 12, the synchronization-mechanism-configuration-output-circuit storing section 13, the synchronization-mechanism-configuration storing section 15, and the synchronization-mechanism-circuit-information storing section 17 may be any storing device including a hard disk, as long as they are storing devices.

The test-circuit storing section 11 stores test circuit information for validating an integrated circuit to be designed (generated).

The circuit-information storing section 12 stores operation information of integrated circuit to be designed.

The synchronization-mechanism-configuration-output-circuit storing section 13 stores operation information of a circuit for compiling configuration information of the synchronization mechanism during a simulation.

The synchronization-mechanism-configuration storing section 15 stores the synchronization-mechanism configuration information which is supplied by the simulation device 14 as a synchronization-mechanism-generation-information generating device and which is compiled by the synchronization-mechanism-configuration-output-circuit storing section 13 when the simulation is performed by the simulation device 14.

The synchronization-mechanism-circuit-information storing section 17 stores circuit information of a synchronization mechanism supplied from the synchronization-mechanism generating device 16.

The simulation device 14 and the synchronization-mechanism generating device 16 are configured by a work station, for example. The simulation device 14 and the synchronization-mechanism generating device 16 may be any calculating device.

The simulation device 14 is configured to be able to perform a simulation in which the circuit information of the test circuit, the circuit information of the integrated circuit, and that the circuit information of the synchronization-mechanism-configuration output circuit, each of which being stored in the test-circuit storing section 11, the circuit-information storing section 12, and the synchronization-mechanism-configuration-output-circuit storing section 13 are used.

The synchronization-mechanism generating device 16 as a circuit generating device generates circuit information of an optimal synchronization mechanism based on the synchronization-mechanism configuration information stored in the synchronization-mechanism-configuration storing section 15.

The display device 18 is configured by a CRT, for example, and is capable of displaying the synchronization-mechanism circuit information stored in the synchronization-mechanism-circuit-information storing section 17.

The display device 18 may be any display device including a liquid crystal display or the like.

Hereinafter, a description is given of a more specific configuration and function of the integrated-circuit generating device 10 as the synchronization-mechanism-circuit generating device.

Firstly, a description is given of what circuit the synchronization mechanism circuit is.

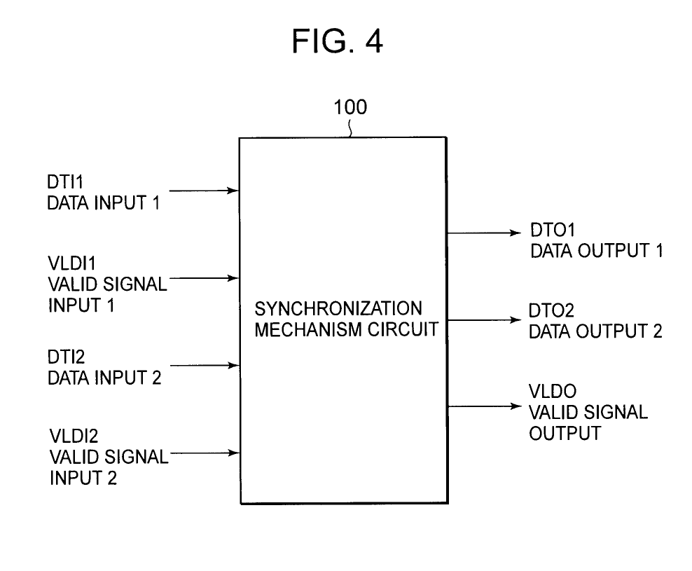

FIG. 4 is a diagram for describing the synchronization mechanism circuit.

In FIG. 4, the number of data inputs and that of valid signal inputs are two, respectively, but the numbers may be more than two.

A plurality of data DT, together with valid signals VLD, are inputted to the synchronization mechanism circuit 100.

The valid signal VLD is a signal which indicates whether valid value is set to first and second data inputs DTI1 and DTLI2, each of which forms a pair with first and second valid signal inputs VLDI1 and VLDI2 at a certain time.

In the synchronization mechanism circuit 100, a plurality of inputted data are temporarily stored, and when valid values are inputted out of all data inputs, a value inputted from each data input is outputted from each data output. At this time, a value indicating that valid data is outputted is set to a valid signal output VLDO.

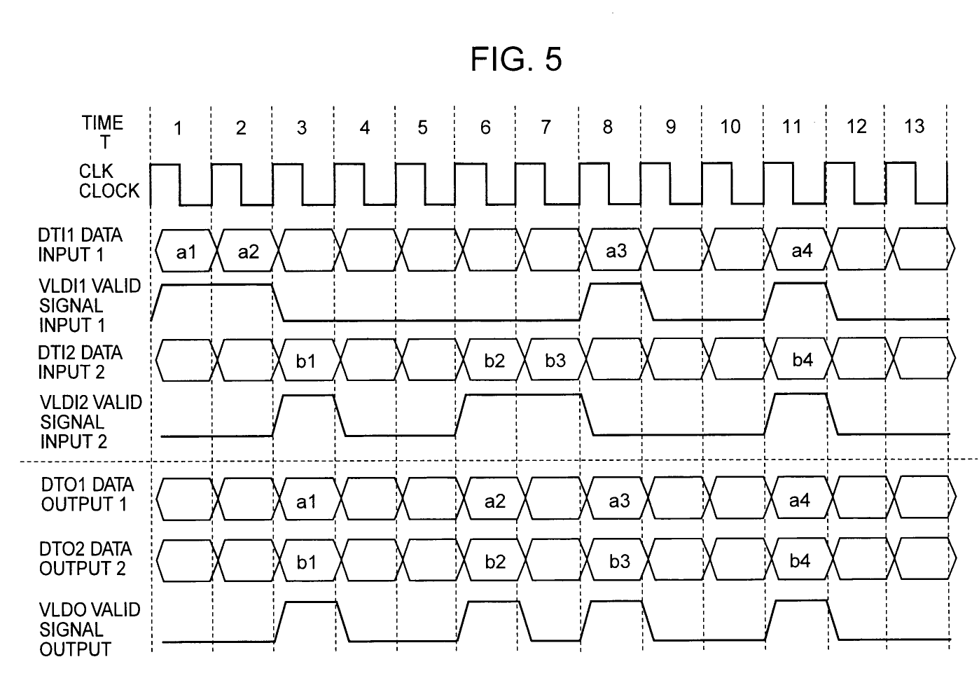

FIG. 5 is a chart showing one example of a timing chart in a case where the synchronization mechanism circuit is operated.

As shown in FIG. 5, a valid signal VLD is valid when it reaches a “high” level and invalid when it is a “low” level.

In FIG. 5, at a time T1, first valid data is inputted from the data input DTI1. At the time T1, since no valid data is inputted from the data input DTI2, a value “a1” inputted from the data input DTI1 is stored in the synchronization mechanism circuit 100 so that the value “a1” can be outputted at a later time.

At a time T2, next valid data is inputted from the data input DTI1. Even at the time T2, since no valid data is inputted from the data input DTI2, a value “a2” inputted from the data input DTI1 is stored in the synchronization mechanism circuit 100 so that the value “a2” can be outputted at a later time.

At a time T3, valid data “b1” is inputted from the data input DTI2. At this time, since the valid data together with the data inputs DTI1 and DTI2 are prepared, the value “a1” firstly inputted from the data input DTI1 is outputted from a data output DTO1 and the value “b1” firstly inputted from the data input DTI2 is outputted from a data output DTO2. Thereby, a valid signal output VLDO becomes “High”.

Similarly, at the time that the valid values inputted from the data inputs DTI1 and DTI2 are prepared, values are outputted from the data outputs DTO1 and DTO2. Thereby, the valid signal becomes “High”. Such a process is repeated.

A circuit for performing such an operation is referred to as a synchronization mechanism circuit.

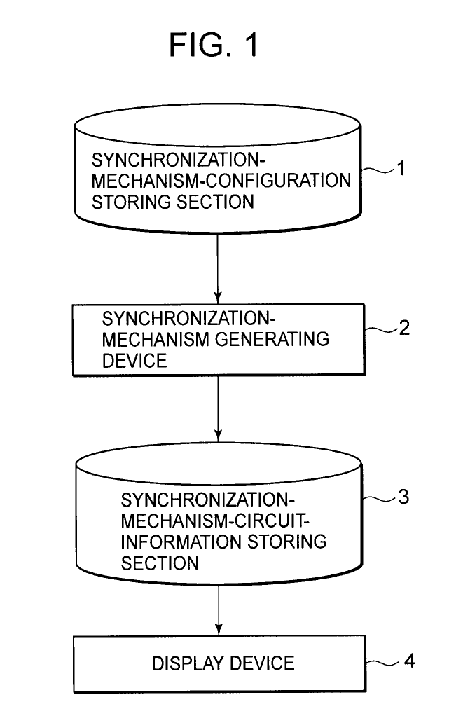

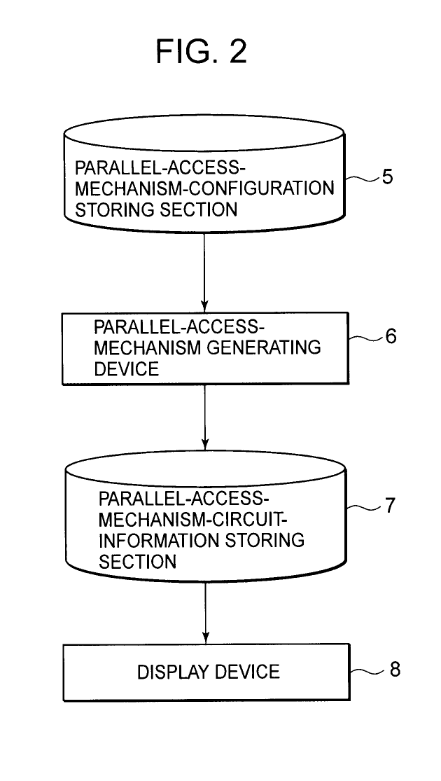

So far, to generate a synchronization-mechanism circuit, it has been required to provide a synchronization mechanism configuration to the synchronization-mechanism generating device, as shown in FIG. 1.

In contrary thereto, in the embodiment, by means of a simulation realized by the test-circuit storing section 11, the circuit-information storing section 12, the synchronization-mechanism-configuration-output-circuit storing section 13, and the simulation device 14, the configuration of the synchronization mechanism is generated, whereby the synchronization mechanism circuit 100 is generated, as shown in FIG. 3.

This eliminates a necessity of inputting the configuration information of the synchronization mechanism, and thus, the optimal synchronization mechanism circuit 100 may be generated in a short period of time.

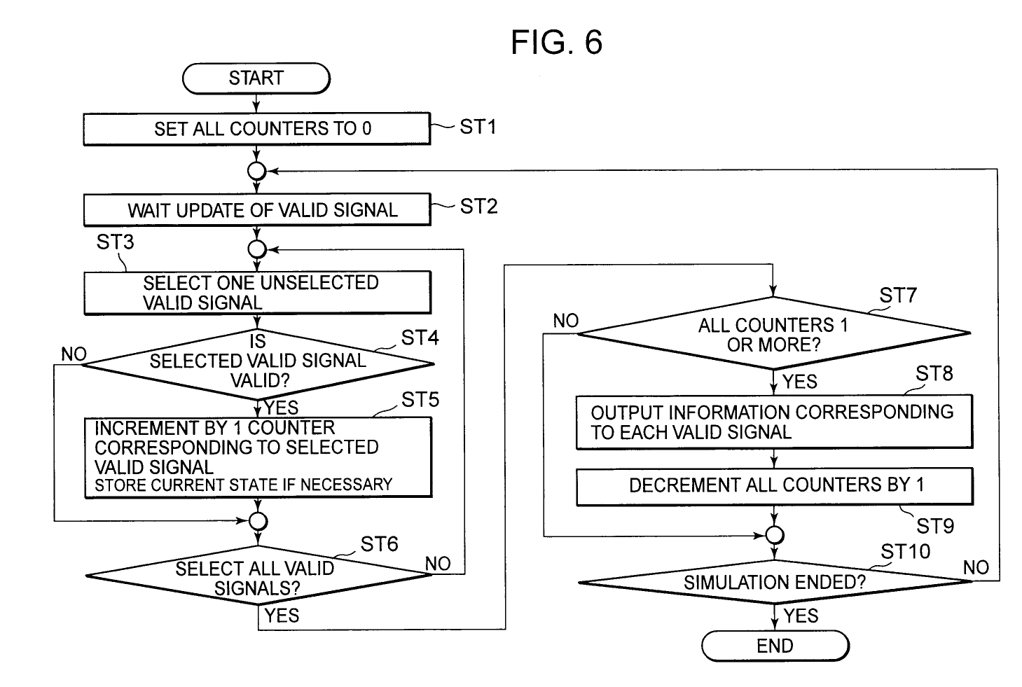

With reference to a flowchart in FIG. 6, a description is given of an operation for generating the synchronization-mechanism configuration information by performing a simulation in the simulation device 14 using information stored in the test-circuit storing section 11, the circuit-information storing section 12, and the synchronization-mechanism-configuration-output-circuit storing section 13.

When the simulation of the circuit information of the synchronization-mechanism-configuration output circuit stored in the synchronization-mechanism-configuration-output-circuit storing section 13 is begun in the simulation device 14, all counters in the synchronization-mechanism-configuration output circuit are firstly initialized to 0 (ST1).

Subsequently, the synchronization-mechanism-configuration output circuit waits for an update of the valid signal VLD (ST2). One example of a timing at which the valid signal VLD is updated is a rise or a fall of a clock signal CLK, for example.

After the valid signal VLD is updated, whether a value of each valid signal VLD indicates valid or not is successively examined (ST3, ST4).

When the valid signal VLD indicating valid is found, a value of a counter which corresponds to the selected valid signal is added by 1. At this time, a current state is stored, if necessary (ST5).

For example, one example is that a time at which a current simulation is progressed is stored in a storing element which corresponds to the selected valid signal.

When all values of the valid signals VLD are examined (ST6), whether all counter values are 1 or more are subsequently confirmed (ST7).

When all counter values are 1 or more, information corresponding to each valid signal is outputted (ST8), and the value of each counter is decremented by 1 (ST9).

For example, one example is that the number of each valid signal inputted so far or a time at which each valid signal is inputted during the simulation is outputted. Finally, whether the simulation is ended or not is confirmed (ST10), and when the simulation is not ended, the process returns to a waiting for the update of the subsequent valid signal VLD.

When a simulation result by the simulation device 14 is stored in the synchronization-mechanism-configuration storing section 15, the information stored in the synchronization-mechanism-configuration storing section 15 is next used to generate the synchronization mechanism by the synchronization-mechanism generating device 16.

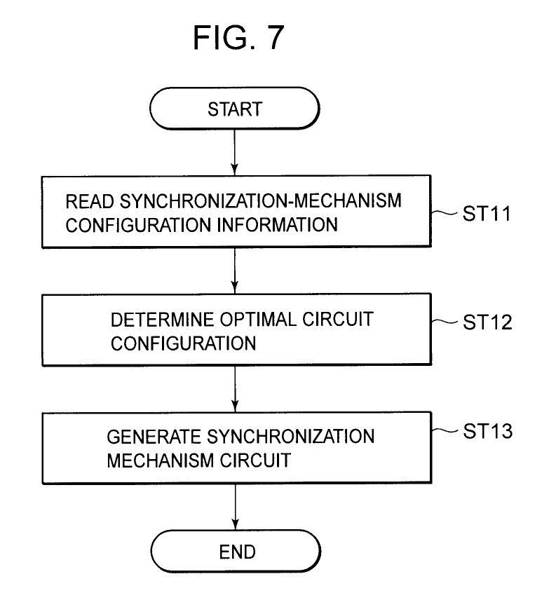

With reference to a flowchart in FIG. 7, an operation for generating the synchronization mechanism by the synchronization-mechanism generating device 16 is described.

Firstly, the synchronization-mechanism configuration information stored in the synchronization-mechanism-configuration storing section 15 is read (ST11). Subsequently, a circuit configuration most appropriate for the configuration information is determined (ST12). Finally, the synchronization mechanism circuit 100 is generated based on the circuit configuration (ST13).

When the synchronization mechanism circuit is generated by the synchronization-mechanism generating device 16, the circuit information is stored in the synchronization-mechanism-circuit-information storing section 17.

A more specific configuration example is described next.

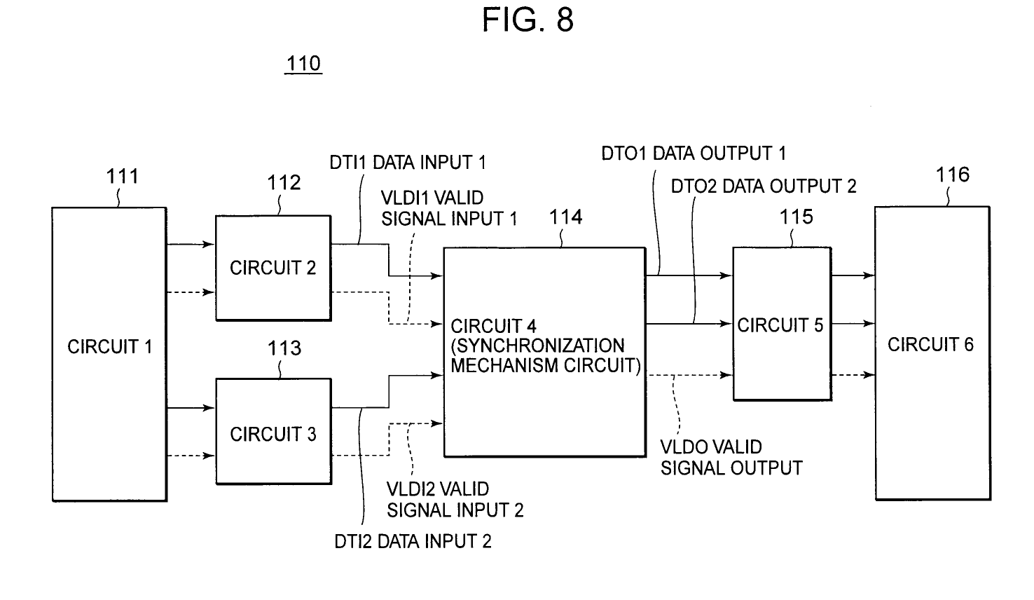

FIG. 8 is a diagram showing an example of an integrated circuit realized by the embodiment.

To an integrated circuit 110, first to sixth circuits 111 to 116 (circuit 1 to circuit 6) are connected in a cascade and parallel manner, as shown in FIG. 8.

The first and sixth circuits 111, 116 represent test circuits for validating the integrated circuit 110. The second, third, and fifth circuits 112, 113, and 115 represent circuits other than the synchronization mechanism circuit. The fourth circuit 114 represents the synchronization mechanism circuit generated by the embodiment.

The fourth circuit 114 as the synchronization mechanism circuit generated by the embodiment, realizes by the optimal circuit product quality, a function for making timings of the values inputted from the second and third circuits 112 and 113 coincident with each other and outputting the timings to the fifth circuit 115.

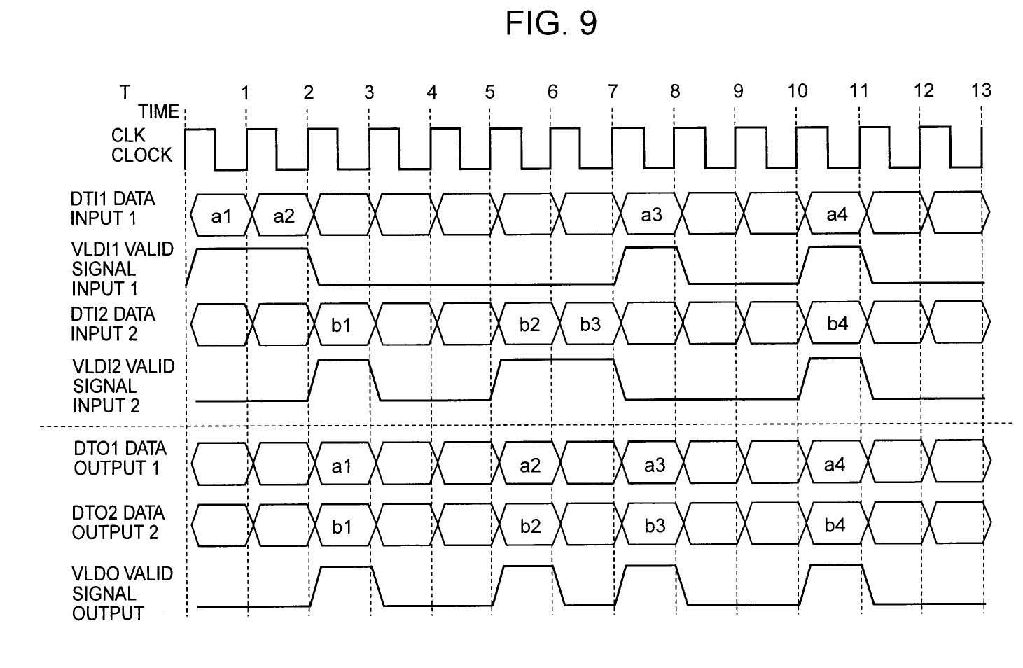

FIG. 9 shows a timing chart showing an operation example of the fourth circuit (synchronization mechanism circuit) in FIG. 8.

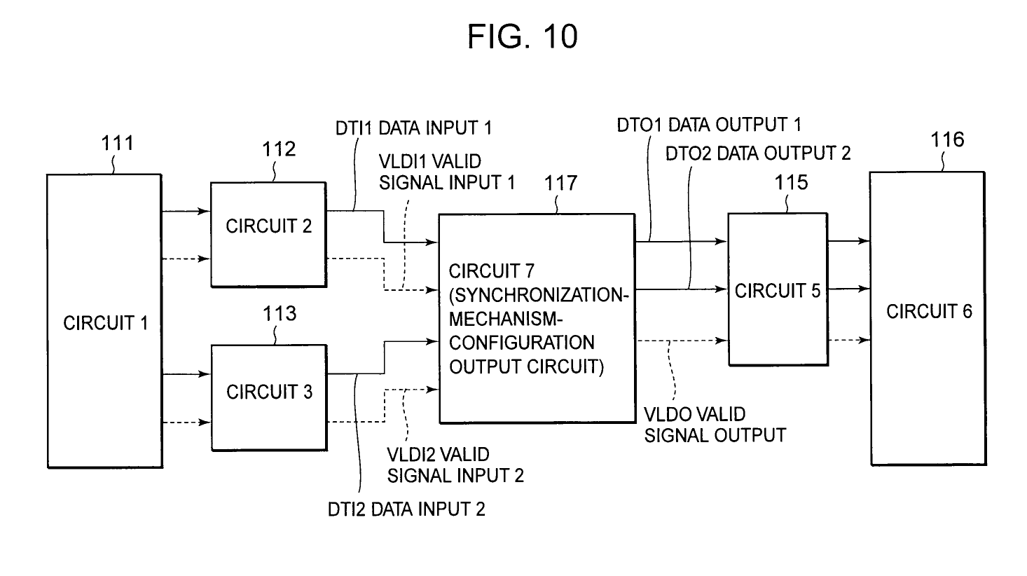

FIG. 10 is a diagram showing information inputted into an output-synchronization-mechanism generating device of a parallel process according to the embodiment.

Although overlapped to the description in FIG. 8, the first and sixth circuits 111 and 116 in FIG. 10 are test circuits for validating the integrated circuit, and are stored in the test-circuit storing section 11 in FIG. 3. The second, third, and fifth circuits 112, 113, and 115 in FIG. 10 are circuits excluding the synchronization mechanism circuit, and the circuit information is stored in the circuit-information storing section 12 in FIG. 3. A seventh circuit in FIG. 10 is a synchronization-mechanism-configuration output circuit, and circuit information thereof is stored in the synchronization-mechanism-configuration-output-circuit storing section 13 in FIG. 3.

Firstly, a description is given of an overview of the operation.

Firstly, the data inputs DTI1 and DTI2 and the valid signal inputs VLDI1 and VLDI2, which are inputs of the synchronization-mechanism-configuration output circuit (the circuit 7 in FIG. 10) 117, are inputted with signals (FIG. 9) to be corresponded with the synchronization mechanism circuit (the circuit 4 in FIG. 8) 114, and in this state, the simulation is performed.

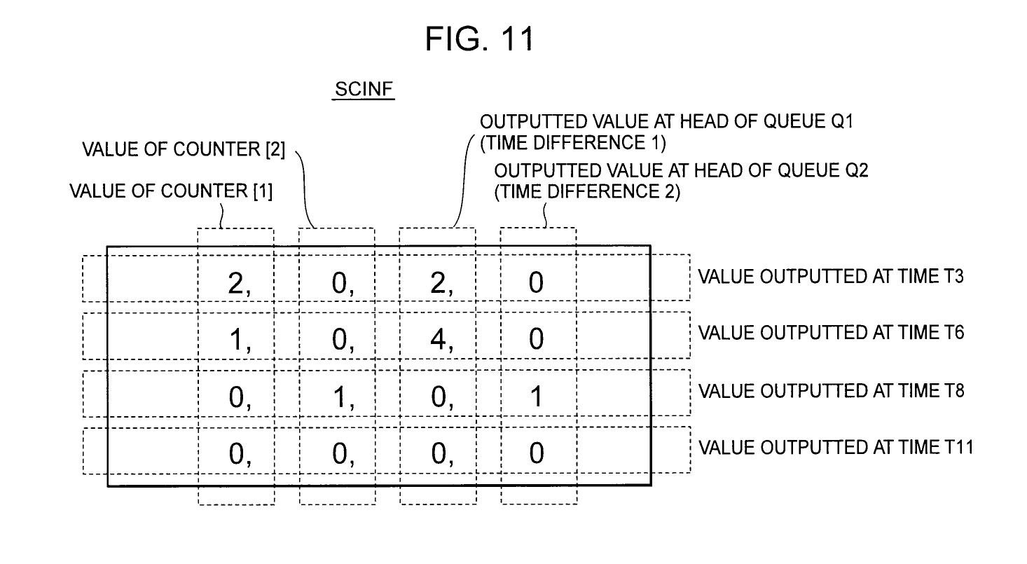

At this time, values of a counter and a queue Q temporarily assumed in the synchronization-mechanism-configuration output circuit 117 are stored as synchronization-mechanism configuration information SCINF as shown in FIG. 11, for example.

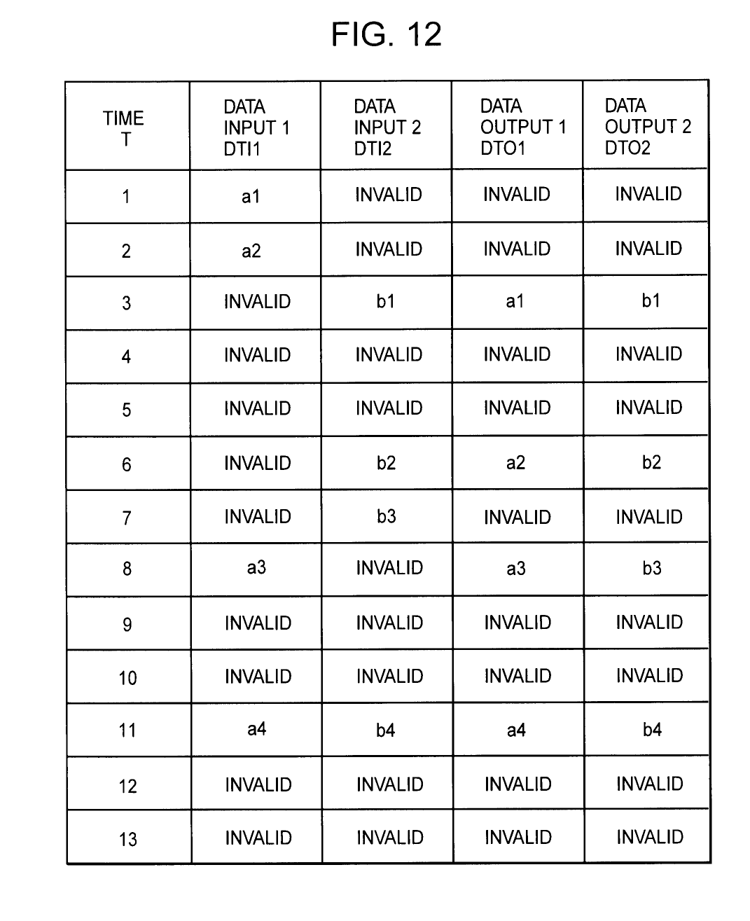

Further, as shown in FIG. 12, the synchronization-mechanism-configuration-output-circuit storing section 117 causes artificially ideal behavior of the synchronization mechanism circuit, and performs the simulation.

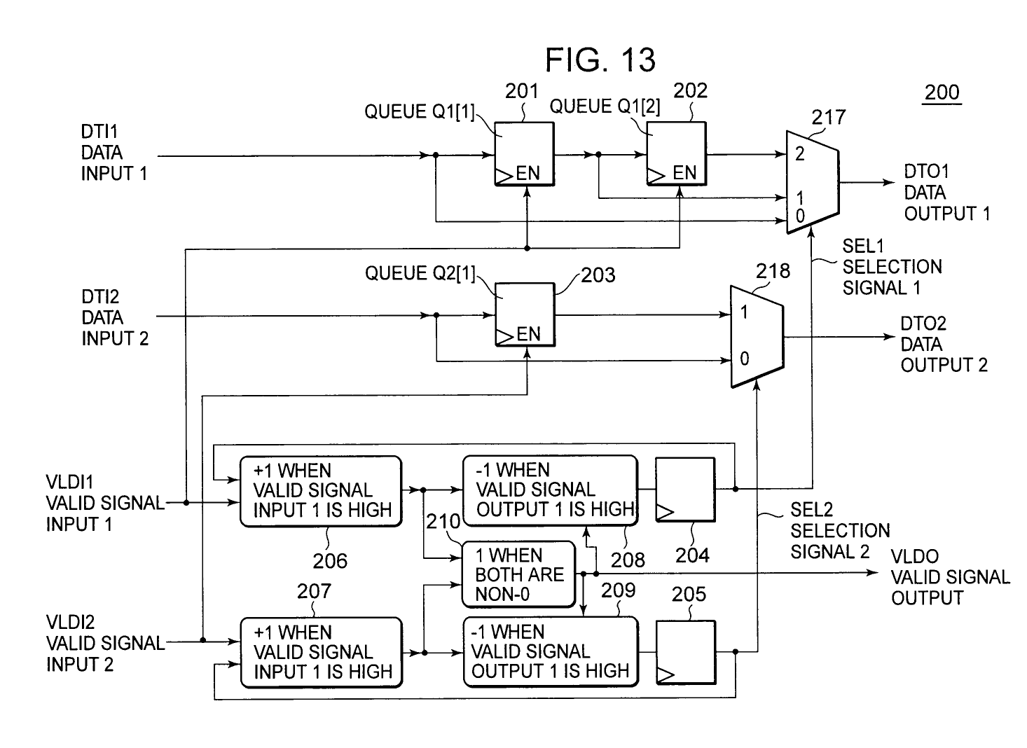

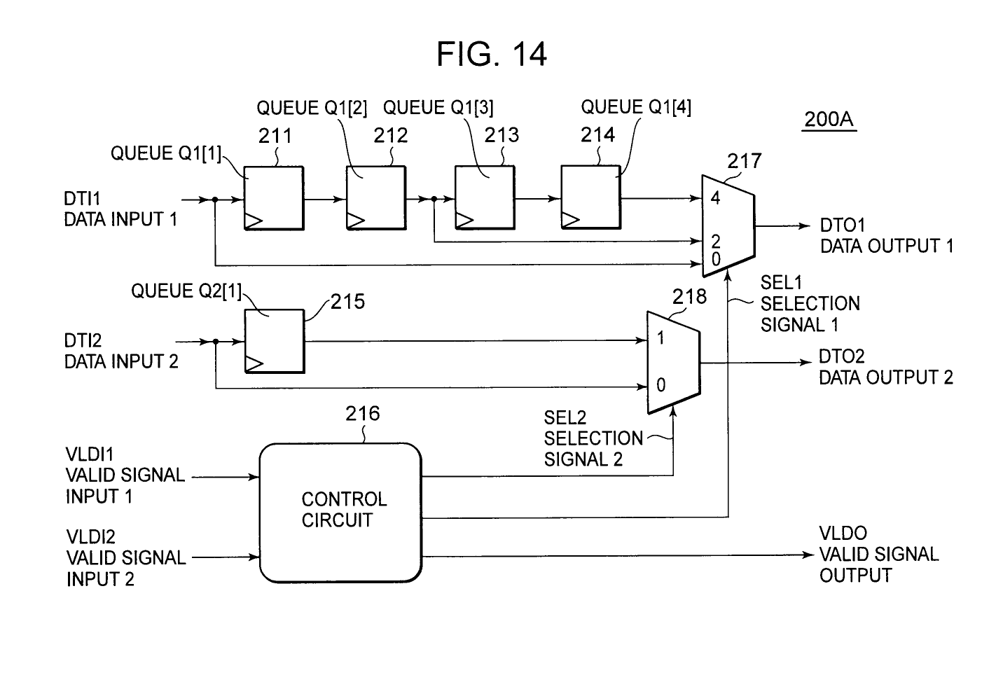

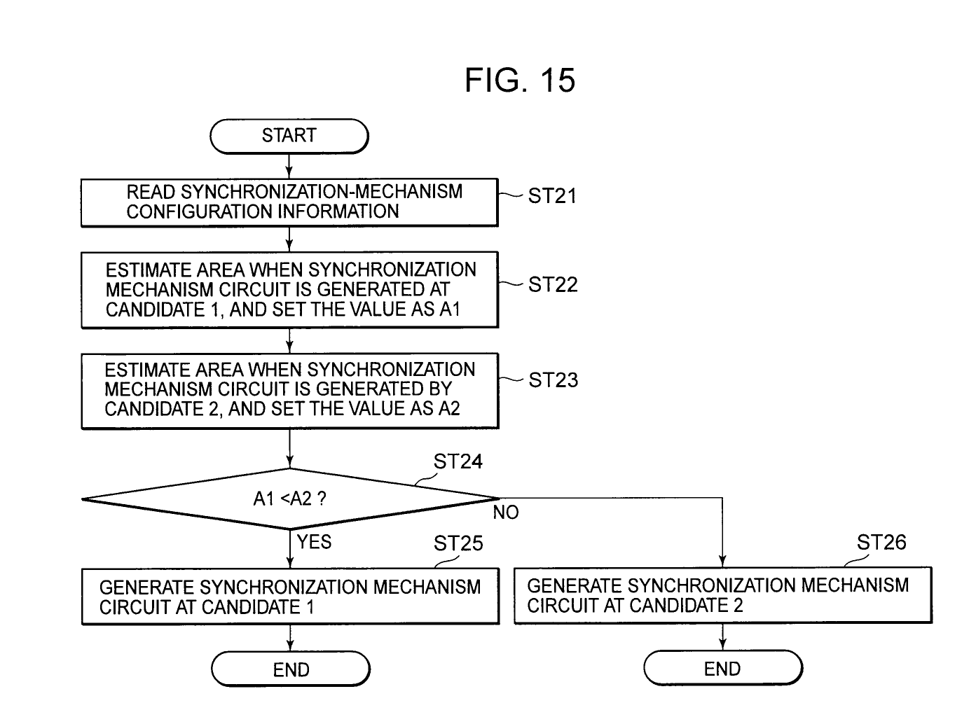

Based on the synchronization-mechanism configuration information SCINF, a plurality of information of candidates of a circuit configuration which can correspond to the input signals (FIG. 9) are extracted by circuits shown in FIG. 13 and FIG. 14. According to a procedure in FIG. 15, for example, the synchronization mechanism circuit is generated out of the candidates based on a circuit scale, for example.

FIG. 13 is a diagram showing a first configuration example of the synchronization mechanism circuit generated from the synchronization-mechanism configuration information shown in FIG. 11.

The synchronization mechanism circuit 200 includes latches 201, 202, and 203, each of which includes an enable function, latches 204 and 205, arithmetic circuits 206 to 210, and selectors 217 and 218.

The latches 201 and 202 receive first valid signal input VLDI1 as an enable signal, and sequentially latch the first data input DTI1.

The latch 203 receives a second valid signal input VLDI2 as an enable signal, and latches the second data input DTI2.

The arithmetic circuit 206 is fed back with output of the latch 204, and when the first valid signal input VLDI1 is at a high level, the arithmetic circuit 206 adds the output by 1 and outputs it to the arithmetic circuits 208 and 210.

The arithmetic circuit 207 is fed back with output of the latch 205, and when the second valid signal input VLDI2 is at a high level, the arithmetic circuit 207 adds the output by 1 and outputs it to the arithmetic circuits 209 and 210.

The arithmetic circuit 208 decrements the output of the arithmetic circuit 206 by 1 when the valid signal output VLDO outputted from the arithmetic circuit 210 is at a high level (logic 1).

The arithmetic circuit 209 decrements the output of the arithmetic circuit 207 by 1 when the valid signal output VLDO outputted from the arithmetic circuit 210 is at a high level (logic 1).

The arithmetic circuit 210 renders the valid signal output VLDO high level (logic 1) when the both outputs of the arithmetic circuits 206 and 207 are not 0 (at the time of non-0 (zero)).

The latch 204 latches output of the arithmetic circuit 208, and outputs the output to the arithmetic circuit 206 and a first selection signal SEL 1 to the selector 211.

The latch 205 latches output of the arithmetic circuit 209, and outputs the output to the arithmetic circuit 207 and a second selection signal SEL2 to the selector 212.

The selector 211 outputs the output of the latch 202 as first data output DTO1 when the first selection signal SEL1 is 2, outputs the output of the latch 201 as first data output DTO1 when the first selection signal SEL1 is 1, and outputs the first data input DTI1 as the first data output DTO1 when the first selection signal SEL1 is 0.

The selector 212 outputs the output of the latch 203 as second data output DTO2 when the second selection signal SEL2 is 1, and outputs the second data input DTI2 as the second data output DTO2 when the second selection signal SEL2 is 0.

FIG. 14 is a diagram showing a second configuration example of the synchronization mechanism circuit generated from the synchronization-mechanism configuration information shown in FIG. 11.

A synchronization mechanism circuit 200A includes latches 211 to 215, a control circuit 216, and the selectors 217 and 218.₂

The latches 211 to 214 successively latch the first data input DTI1.

The latch 215 latches the second data input DTI2.

In receipt of the first valid signal input VLD1 and the second valid signal input VLD2, the control circuit 216 generates the first selection signal SEL1 and outputs it to the selector 217, generates the second selection signal SEL2 and outputs it to the selector 218, and generates the valid signal output VLDO.

A process of FIG. 15 is performed as follows:

Firstly, the synchronization-mechanism configuration information is read (ST21).

Subsequently, an area in the case where the synchronization mechanism circuit is generated at a candidate 1 is estimated and the value thereof is set to A1 (ST22).

An area in the case where the synchronization mechanism circuit is generated by a candidate 2 is estimated, and the value thereof is set as A2 (ST23).

Thereafter, it is judged whether the area A1 is smaller than the area A2 (ST24).

When the area A1 is smaller, the synchronization mechanism circuit is generated by the candidate 1 (ST25). On the other hand, when the area A1 is not smaller than the area A2, the synchronization mechanism circuit is generated by the candidate 2 (ST26).

Subsequently, description as to the details of the above processes is given.

When the information stored in the test-circuit storing section 11, the circuit-information storing section 12, and the synchronization-mechanism-configuration-output-circuit storing section 13 are inputted to the simulation device 14 to perform the simulation, the configuration information of the synchronization mechanism is outputted.

The synchronization-mechanism-configuration output circuit stored in the synchronization-mechanism-configuration-output-circuit storing section 13 not only output the configuration information of the synchronization mechanism but also behaves like an artificially ideal synchronization mechanism circuit. The reason for this is because when there exits no block for behaving like a synchronization mechanism circuit, the circuits other than the synchronization mechanism circuit are not properly operated, and thus, it is probable that a correct value may not be inputted to the synchronization-mechanism-configuration output circuit.

As one example of the operation, FIG. 12 shows outputs of the ideal synchronization mechanism circuit when the signals shown in FIG. 9 are inputted.

When both the first data input DTI1 and the second data input DTI2 are prepared, the data are immediately outputted to the first data output DTO1 and the second data output DTO2.

For example, when b1 is inputted at the time T3 from the second data input DTI2, the data of the first data input DTI1 and that of the second data input DTI2 are prepared. Thus, a1 inputted firstly from the first data input DTI1 is outputted from the first data output DTO1, and b1 inputted firstly from the second data input DTI2 is outputted from the second data output DTO2.

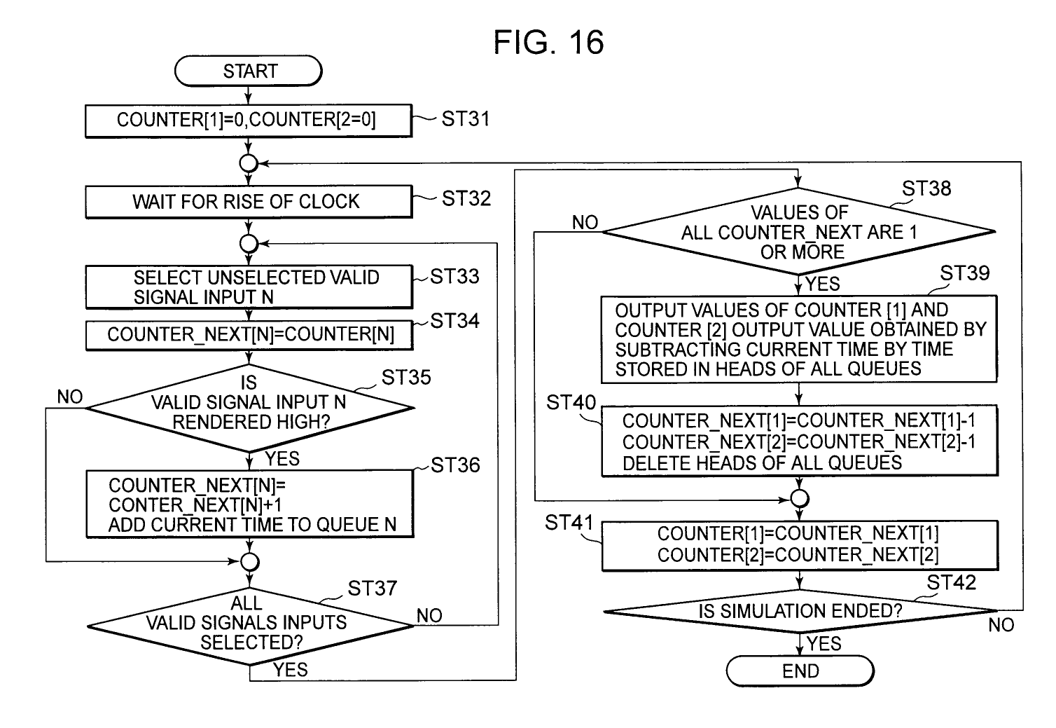

FIG. 16 is a flowchart for describing one example of an operation for outputting the configuration information of the synchronization mechanism.

When the simulation is begun by the simulation device 14, counter[1] and counter[2] are set to 0 (ST31). The counter[1] and the counter[2] each represent numbers of values which are not yet outputted and need to be held in the synchronization mechanism, out of valid values inputted from the first data input DTI1 and the second data input DTI2.

Subsequently, the process waits for a rise of the clock signal CLK (ST32), and when the clock is risen, the valid signal input is selected in order (ST33).

When a valid signal input N is selected, counter_next[N] is firstly initialized by a value of counter[N] (ST34). Subsequently, whether the valid signal input N is at a high level (High) is confirmed (ST35), and when the valid signal input N is High, the counter_next[N] is added by 1 and a current time is added to a queue QN on the simulation (ST36).

When this process is performed, the result is that the counter_next[1] and the counter_next[2] each come to represent the numbers of values which are not yet outputted and need to be held in the synchronization mechanism, including the valid signals inputted from the data inputs DTI1 and the DTI2 at the rise of the clock this time.

When all the valid signal inputs are checked whether they reach High (ST37), subsequently, whether the counter_next[1] and the counter_next[2] are 1 or more are confirmed (ST38). When the counter_next [1] and the counter_next [2] are 1 or more, this means that outputtable valid data are already inputted in the synchronization mechanism.

When the counter_next[1] and the counter_next[2] are 1 or more, the values of the counter[1] and the counter[2] and values obtained by subtracting the current time from values stored in heads of queues Q1 and Q2 are outputted (ST39). The values of the counter_next[1] and the counter_next[2] are decremented by 1, and the values stored in the heads of the queues Q1 and Q2 are deleted from the queue Q (ST40).

The outputted values of the counter[1] and the counter[2] each represent numbers of the values of the data input DTI1 and the data input DTI2 which need to be at least held in the synchronization mechanism at the time that the clock this time rises. The value obtained by subtracting the current time from the value of the head of the queue Q represents a time period required for the value inputted from each data input to be outputted from the data output.

Lastly, the value of the counter is updated by the value of the counter_next (ST41), and when the simulation still continues (ST42), the process returns to the wait for the rise of the clock to repeat the process.

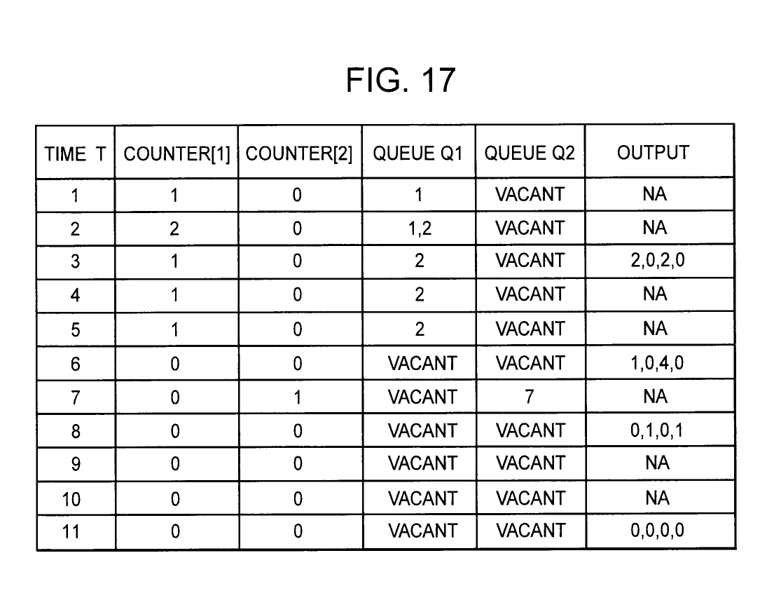

FIG. 17 is a table showing values at each time of the output; the counter[1]; the counter [2]; the queue Q1; and the queue Q2 when the signals shown in FIG. 9 are inputted, as one example of the operation.

At the time T1, only the first valid signal input VLDI1 is High, thus, the value of the counter[1] is added by 1, and 1, which denotes the current time, is added to the head of the queue Q1.

The similar process is performed. At the time T3, the second valid signal input VLDI2 is High, the counter_next [1] becomes 2, the counter_next [2] becomes 1, the queue Q1 becomes “1, 2”, and the queue Q2 becomes “3”.

The counter_next [1] and the counter_next [2] becomes 1 or more. Thus, as the output, 2 which is the value of the counter[1]; 0 which is the value of the counter [2]; 2 which is obtained by subtracting the value 1 of the head of the queue Q1 from the current time T3; and 0 which is obtained by subtracting the value 3 of the head of the queue Q2 from the current time 3 are outputted.

In the description that follows, a value obtained by subtracting the value of the head of the queue Q from the current time is referred to as a time difference TDF.

The similar process is repeated until all the signals shown in FIG. 9 are inputted.

As described above, FIG. 11 shows an example of the configuration information of the synchronization mechanism outputted to the synchronization-mechanism-configuration storing section 15 when the signals shown FIG. 9 are inputted.

The synchronization-mechanism configuration information stored in the synchronization-mechanism-configuration storing section 15 is inputted to the synchronization-mechanism generating device 16 to generate the synchronization mechanism circuit, and the circuit information is outputted to the synchronization-mechanism-circuit-information storing section 17.

FIG. 15 shows an example of a generation operation of the synchronization mechanism circuit performed in the synchronization-mechanism generating device 16 when the synchronization-mechanism configuration information of FIG. 11 is inputted.

Firstly, the synchronization-mechanism configuration information is read (ST21). Subsequently, based on the configuration information, the area in the case where the synchronization mechanism circuit is generated by the configuration candidate 1 is estimated, and the value is set as A1 (ST22). Similarly, an estimated value of the area in the case where the synchronization mechanism circuit is generated by the configuration candidate 2 is set as A2 (ST23).

A calculation of the estimated values is performed according to approximation expressions shown by the below-described expressions (1) and (2), for example. The approximation expression of the area estimate is determined per each architecture of the synchronization mechanism circuit. The area estimates of all the prepared architectures are performed by the approximation expression.

### [Expression 1]

A1={area(storage element)+area(2→1 selector)}*(maximum value of counter[1]+maximum value of counter[2]) (1)

### [Expression 2]

A2=area(storage element)*(maximum value of time difference TDF1+maximum value of time difference TDF2)+area(2→1 selector)*(type of time difference TDF1+type of time difference TDF2−2) (2)

Finally, A1 and A2 are compared (ST24). When A1 is smaller, the candidate 1 is used (ST25) and when A2 is smaller, the candidate 2 is used to generate the synchronization mechanism circuit (ST26).

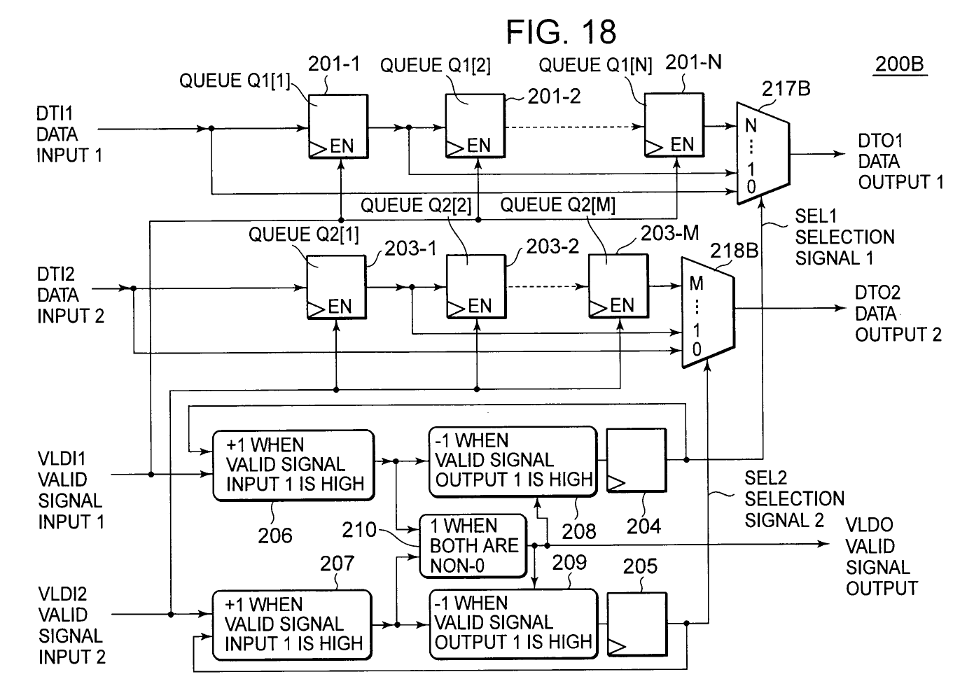

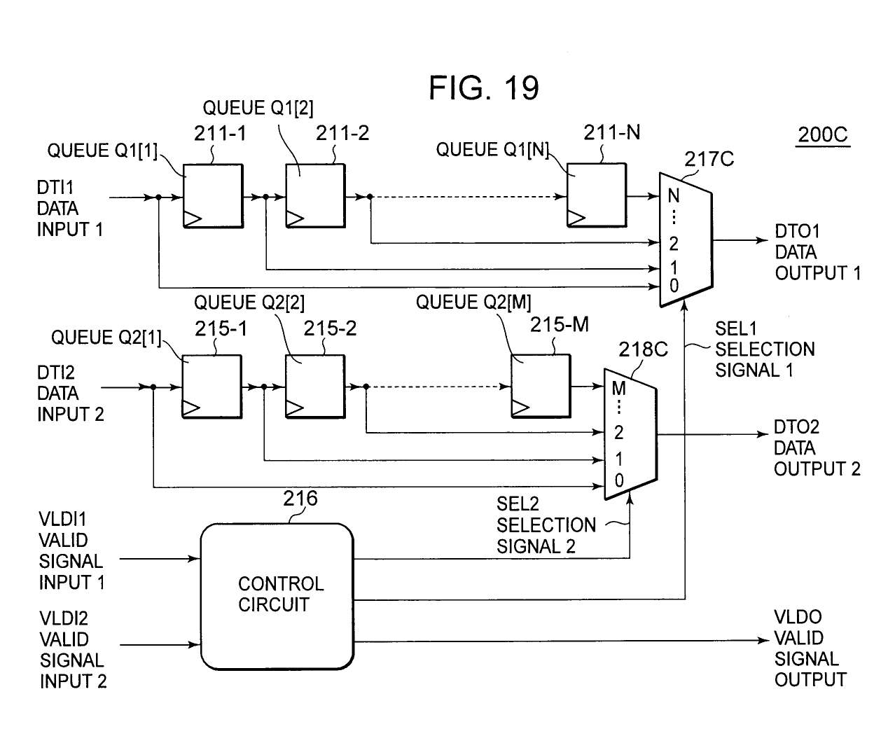

FIG. 18 is a diagram showing an example of the configuration candidate 1. FIG. 19 is a diagram showing an example of the configuration candidate 2.

Difference between a circuit configuration in FIG. 18 and configuration of FIG. 13 resides in that N of latches with enable functions 201-1 to 201-N are disposed in a cascade connection relative to the first data input DTI1, and M of latches with enable functions 203-1 to 201-M are disposed in a cascade connection relative to the second data input DTI2, a selector 211B selects one out of the inputs of N+1 where N is 0 to N and a selector 212B selects one of the inputs of M+1 where M is 0 to M.

A circuit configuration in FIG. 19 differs from configuration of FIG. 14 in that N of latches 211-1 to 211-N are disposed in a cascade connection relative to the first data input DTI1, and M of latches 215-1 to 215-M are disposed in a cascade connection relative to the second data input DTI2, a selector 217C selects one out of the inputs of N+1 where N is 0 to N and a selector 218C selects one out of the inputs of M+1 where M is 0 to M.

The configuration candidate 1 in FIG. 18 is configured to hold only valid values from the data input in the synchronization mechanism circuit.

Before the optimized synchronization mechanism circuit is generated, it is configured to synchronize the input at arbitral timing, as shown in FIG. 18. Only the valid values from the data input are held by the queue Q1 and the queue Q2 in FIG. 18, the selection signal SEL1 and the selection signal SEL2 are used to select the held values, and the values are outputted to the first data output DTO1 and the second data output DTO2.

The number of data, that is, N and M, which are held by the queue Q1 and the queue Q2 are set to the maximum values of the counter[1] and counter[2], respectively, out of the synchronization-mechanism configuration information shown in FIG. 11. A synchronization mechanism circuit of the configuration 1 generated from the synchronization-mechanism-configuration information shown in FIG. 11 is the circuit shown in FIG. 13.

Since the maximum value of the counter [1] is 2 and that of the counter[2] is 1, the queue Q1 becomes 2 and the queue Q2 becomes 1, respectively.

The area of the configuration 1 is dominated by an area of storing elements and that of selectors. Therefore, the approximation expression for estimating the area of the configuration 1 is a sum of a total area of storage elements and that of selectors.

The numbers of storage elements is determined by the number of queue Q1 and the queue Q2, that is, the maximum values of the counter[1] and the counter [2]. Further, the number of 2→1 selectors is also determined by the number of queue Q1 and the queue Q2, that is, the maximum values of the counter[1] and the counter[2]. Therefore, the approximation expression for the area is the equation (1). The equation is used to obtain A1.

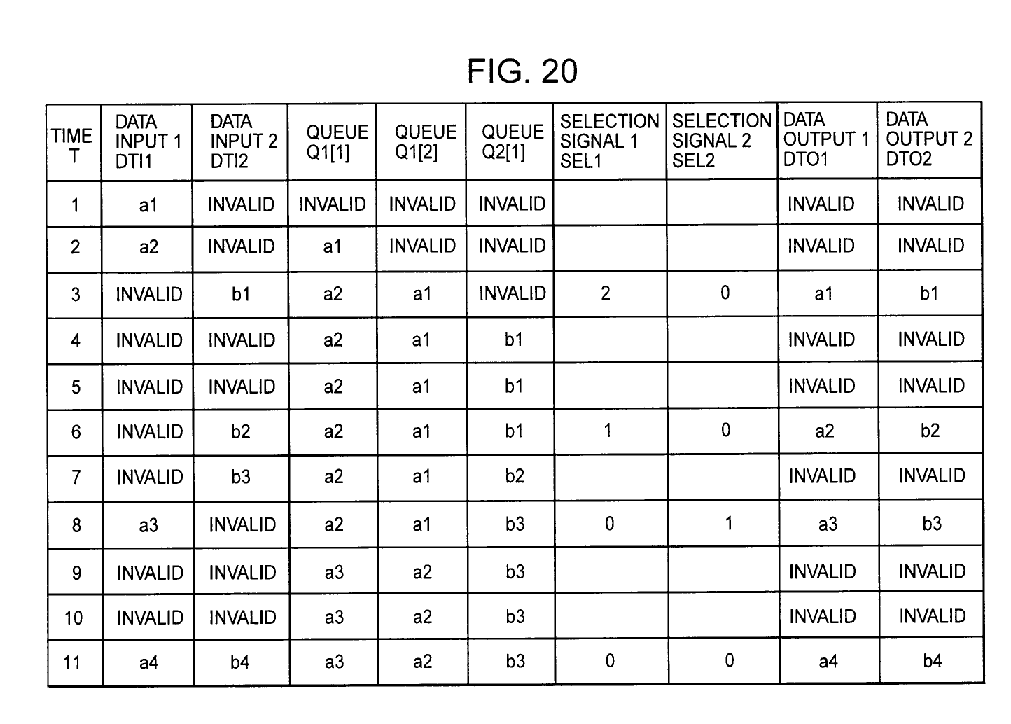

FIG. 20 is a table showing an example of an operation when the signals shown in FIG. 9 are inputted to the circuit of FIG. 18.

When a1 is inputted from the first data input DTI1 at the time T1, the value is held by queue Q1[1] at the time T2.

When a2 is inputted from the first data input DTI1 at the time T2, the queue Q1[1] holds a2 and the queue Q1[2] holds a1 at the time T3.

At the time T3, b1 is already inputted from the second data input DTI2, and thus, the first data can be outputted. As a result, the selection signal SEL1 becomes 2 and selects a1 of the queue Q1[2]. Similarly, the selection signal SEL2 becomes 0, and selects b1 of the data input 2 which is currently being inputted.

As a result, a1 is outputted from the first data output DTO1 and b1 is outputted from the second data output DTO2.

The configuration candidate 2 in FIG. 19 is configured to hold in the synchronization mechanism circuit both the valid values and the invalid values from the data input.

Before the optimized synchronization mechanism circuit is generated, it is configured to synchronize the input at arbitrary timing, as shown in FIG. 19. The values from the data input are held by the queue Q1 and the queue Q2 without judging whether the values are valid or invalid in FIG. 19, the held values are selected by the selection signal SEL1 and the selection signal SEL2, and the values are outputted to the first data output DTO1 and the second data output DTO2.

The number of data, that is, N and M, which are held by the queue Q1 and the queue Q2 are set to the maximum values of a time difference TDF1 and a time difference TDF2, respectively, out of the synchronization-mechanism-configuration information shown in FIG. 11. The input of the selector is deleted because the values which are not taken by the time difference TDF1 and the time difference TDF2 are unnecessary. A synchronization mechanism circuit of the configuration 2 generated from the synchronization-mechanism-configuration information shown in FIG. 11 is the circuit shown in FIG. 14.

Since the maximum value of the time difference TDF1 is 4 and that of the time difference TDF2 is 1, the queue Q1 becomes 4 and the queue Q2 becomes 1, respectively. Further, the time difference TDF1 only takes 0, 2, and 4, and the time difference TDF2 only takes 0 and 1. Thus, 1 and 3 of the time difference TDF1 is unnecessary. Because of this, out of inputs of a selector 217C for data output 1, inputs connected to the output of the queue Q1[1] and those connected to the queue Q1[3] are deleted.

The area of the configuration 2 is dominated by an area of storage elements and that of selectors. Therefore, the approximation expression for estimating the area of the configuration 2 is a sum of a total area of storage elements and that of selectors.

The number of storage elements is determined by the number of queue Q1 and the queue Q2, that is, the maximum values of the time difference TDF1 and the time difference TDF2. The number of 2→1 selectors is as follows: (the number of values taken by the time difference TDF1 and those taken by the time difference TDF2), −2. In the case of the synchronization-mechanism-configuration information shown in FIG. 11, since the numbers of the time difference TDF1 is 3, that is, 0, 2, and 4, and the numbers of the time difference TDF2 is 2, that is, 0 and 1. As a result, the number of 2→1 selectors becomes 3, by 3+2−2. Therefore, the approximation expression for the area is the equation (2). The equation (2) is used to obtain A2.

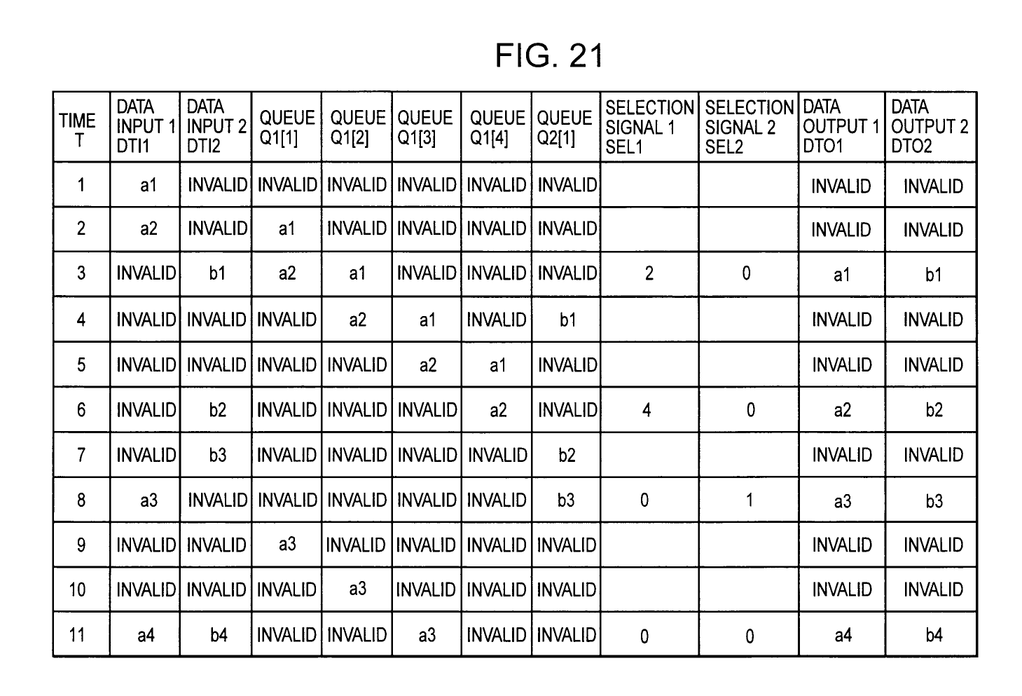

FIG. 21 is a table showing an example of an operation when the signals shown in FIG. 9 are inputted to the circuit of FIG. 19.

The values of the first data input DTI1 and the second data input DTI2 are held by queue Q1 and queue Q2 without judging whether values are valid or invalid, thus, the queue Q1[N] holds a value of the data input 1 of an N time before and the queue Q2 [N] holds a value of the data input DTI2 of an N time before.

That is, the queue Q1[3] at a time T5 holds a value of three times before the time T5, and thus, the queue Q1[3] holds a value of the data input DTI1 of the time T2, that is, a2.

The selection signal SEL1 and the selection signal SEL2 represent whether to output the value of the first data input DTI1 and that of the second data input DTI2 of how many times before.

For example, at the time T3, the value of a1 of the data input 1 of two times before and the value b1 of the current second data input DTI2 are selected and outputted to the first data output DTO1 and the second data output DTO2, and thus, the selection signal SEL1 becomes 2 and the selection signal SEL2 becomes 0.

As described above, according to the first embodiment, the synchronization-mechanism-circuit generating device 10 includes the test-circuit storing section 11 for storing the test circuit information for validating the integrated circuit, the circuit-information storing section 12 for storing the circuit information, the synchronization-mechanism-configuration-output-circuit storing section 13 for generating the configuration information of the synchronization mechanism during the simulation, the simulation device (configuration-information generating device) 14 of the circuit information stored in the test-circuit storing section 11, the circuit-information storing section 12, and the synchronization-mechanism-configuration-output-circuit storing section 13, the synchronization-mechanism-configuration storing section 15 for storing the synchronization-mechanism configuration information compiled by the synchronization-mechanism-configuration-output-circuit storing section 13 when the simulation is performed by the simulation device 14, the synchronization-mechanism generating device 16 for generating the circuit information of the synchronization mechanism based on the synchronization-mechanism configuration information stored in the synchronization-mechanism-configuration storing section 15; the synchronization-mechanism-circuit-information storing section 17 for storing the circuit information of the synchronization mechanism outputted from the synchronization-mechanism generating device 16, and the display device 18 for displaying the circuit information of the generated synchronization mechanism. Therefore, the below-described effects may be obtained.

That is, according to the embodiment, the synchronization mechanism of the value outputted from the circuits operative in parallel may be generated without inputting a specification of the synchronization mechanism. Further, even when a timing specification of the circuit is changed, it may be possible to easily re-generate the optimal synchronization mechanism. As a result, a period of designing the synchronization mechanism may be greatly reduced.

### Second Embodiment

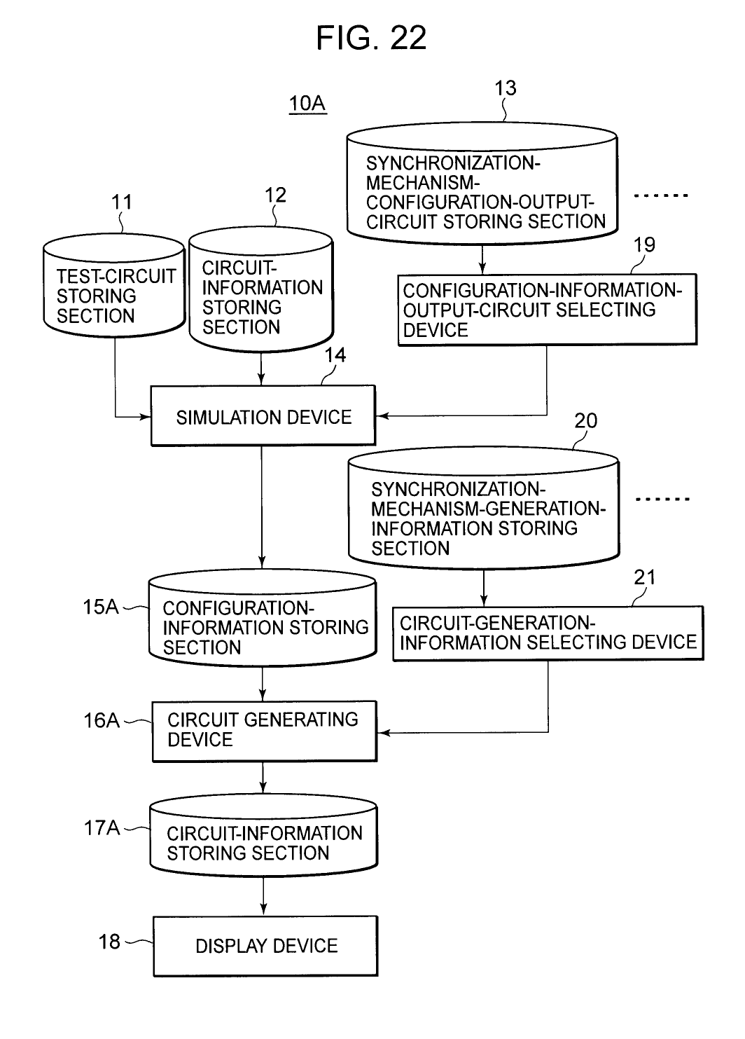

FIG. 22 is a diagram showing a configuration example of an integrated-circuit generating device according to a second embodiment of the present invention.

An integrated circuit generating device 10A according to the second embodiment differs from the integrated circuit generating device 10 of the first embodiment in that a configuration-information-output-circuit selecting device 19 for selectively supplying to the simulation device 14 not only the information of the synchronization-mechanism-configuration-output-circuit storing section 13 and but also that of one of or a plurality of configuration-information-output-information storing sections is provided, and further a circuit-generation-information selecting device 21 for selectively supplying to a circuit generating device 16A not only information of the synchronization-mechanism-generation-information storing section 20 and but also that of one of or a plurality of circuit-generation-information storing sections is provided.

The integrated-circuit generating device 10A having such a configuration may be capable of handling not only the synchronization mechanism circuit but also other circuit generations.

To achieve this, instead of the synchronization-mechanism-configuration storing section 15 in FIG. 3, a configuration-information storing section 15A is disposed, instead of the synchronization-mechanism generating device 16, a circuit generating device 16A is disposed, and instead of the synchronization-mechanism-circuit-information storing section 17, a circuit-information storing section 17A is disposed.

According to the second embodiment, there are advantages in that it is not only possible to obtain the effect of the first embodiment, but also available to a plurality types of circuit generations.

### Third Embodiment

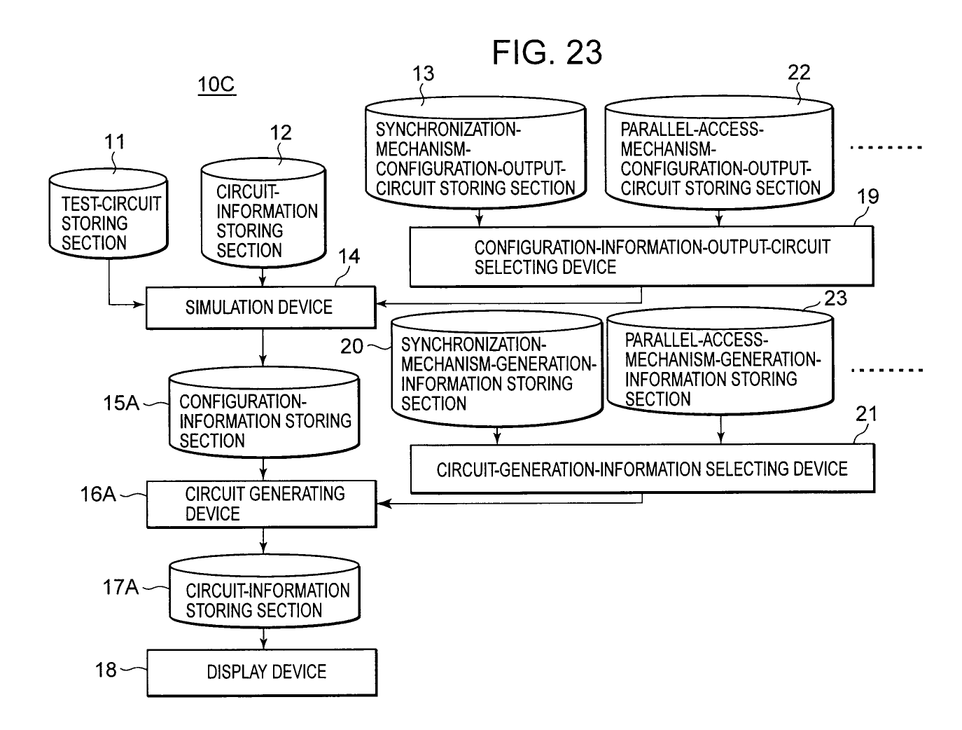

FIG. 23 is a diagram showing a configuration example of an integrated-circuit generating device according to a third embodiment of the present invention.

An integrated-circuit generating device 10B according to the third embodiment differs from the integrated-circuit generating device 10A of the second embodiment in that the synchronization-mechanism-configuration-output-circuit storing section 13 as well as a parallel-access-mechanism-configuration-output-circuit storing section 22 are connected to the configuration-information-output-circuit selecting device 19, and the synchronization-mechanism-generation-information storing section 20 as well as a parallel-access-mechanism-generation-information storing section 23 are connected to the circuit-generation-information selecting device 21, thereby enabling generation of a synchronization mechanism circuit or a parallel-access mechanism circuit.

Hereinafter, a description is mainly given of a method for generating the parallel access mechanism.

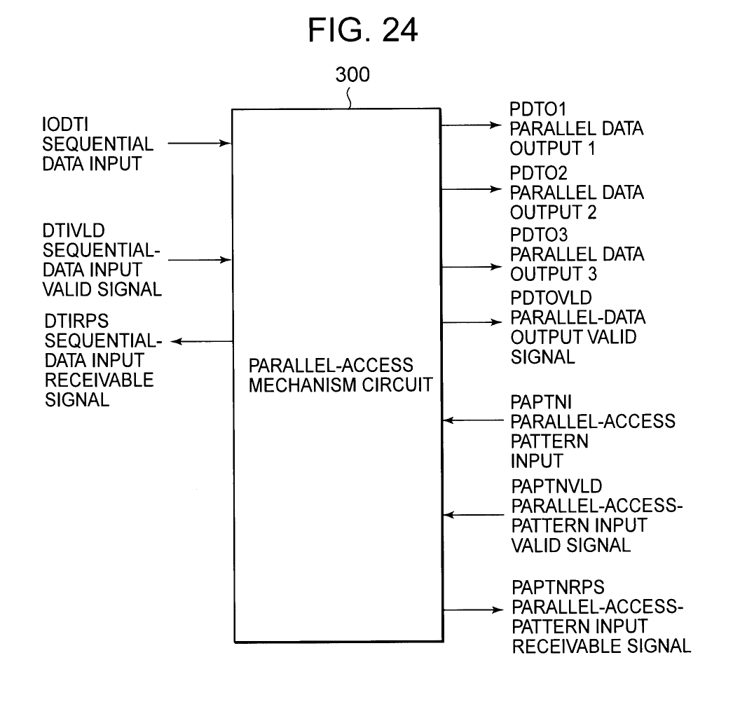

FIG. 24 is a diagram for describing the parallel-access mechanism circuit.

In FIG. 24, the number of a sequential data input IODTI, that of a sequential data input valid signal DTIVLD, and that of a sequential-data-input receivable signal DTIRPS are 1, respectively; that of parallel data outputs PDTO is 3; that of a parallel data output valid signal PDTOVLD is 1; and that of a parallel access pattern input PAPTNI, that of a parallel access pattern input valid signal PAPTNVLD, and that of a parallel access pattern input receivable signal PAPTNRPS are 1, respectively. However, these numbers may not be limited to those in FIG. 24, and may be greater than those.

A parallel-access mechanism circuit 300 is inputted with, together with the valid signal VLD, sequential data, and inputted with, together with the valid signal VLD, a parallel access pattern. These are outputted from the parallel data outputs PDTO1 to PDTO3 corresponding to a value of the parallel-access pattern input PAPTNI.

The valid signal VLD is a signal indicating whether valid values are set to the sequential data input IODTI and the parallel access pattern input PAPTNI which form a pair with the valid signal inputs at a certain time.

The parallel-access mechanism circuit 300 outputs an input receivable signal RPS. The input receivable signal RPS is a signal indicating whether the parallel-access mechanism circuit 300 is capable of receiving the sequential data input IODTI and the parallel access pattern input PAPTNI which form a pair with the input receivable signals at a certain time. In a period during which the parallel-access mechanism circuit 300 is not capable of receiving, it may be necessary to hold the respective signals without updating the signals.

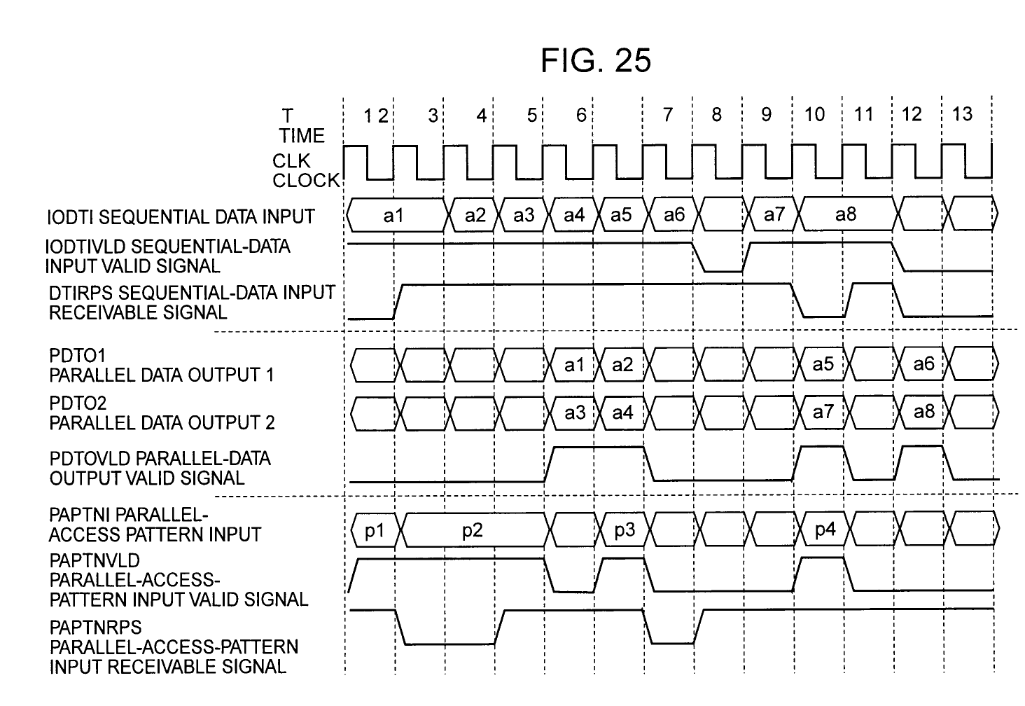

FIG. 25 is a chart showing one example of a timing chart when the parallel-access mechanism circuit is operated.

As shown in FIG. 25, the valid signal VLD indicates valid when it reaches a high level and indicates invalid when it reaches a low level. Similarly, the receivable signal RPS indicates receivable when it reaches a high level and indicates unreceivable when it reaches a low level.

In FIG. 25, at the time T1, first valid data from the data input DTI1 becomes inputtable and at this time, the sequential-data-input receivable signal DTIRPS is low. At the time T2, the receivable signal DTIRPS becomes high. Data of the valid value a1 is inputted at this point.

Subsequently, data of the value a2 is inputted at the time T3; data of a value a3 is inputted at a time T4; data of a value a4 is inputted at a time T5; data of a value a5 is inputted at a time T6; data of a value a6 is inputted at a time T7; data of a value a7 is inputted at a time T9; and data of a value a8 is inputted at a time T11.

At the time T1, the parallel-access-pattern valid signal PAPTNVLD and the receivable signal PAPTNRPS as well are high, and thus, a parallel pattern p1 is inputted. At the times T2 and T3, the receivable signal PAPTNRPS is low, and becomes high at the time T3. Thus, a parallel-access input pattern P2 is inputted at the time T4. Similarly, a pattern p3 is inputted at the time T6, and a pattern p4 is inputted at the time T10.

In the case where the parallel access pattern is p1, data of the value a1 and that of a3 are outputted from the parallel data outputs DTO1 and DTO2. In the case where the parallel access pattern is p2, data of the value a2 and that of a4 are outputted from the parallel data outputs DTO1 and DTO2. In the case where the parallel access pattern is p4, data of the value a5 and that of a7 are outputted from the parallel data outputs DTO1 and DTO2. In the case where the parallel access pattern is p4, data of the value a6 and that of a8 are outputted from the parallel data outputs DTO1 and DTO2.

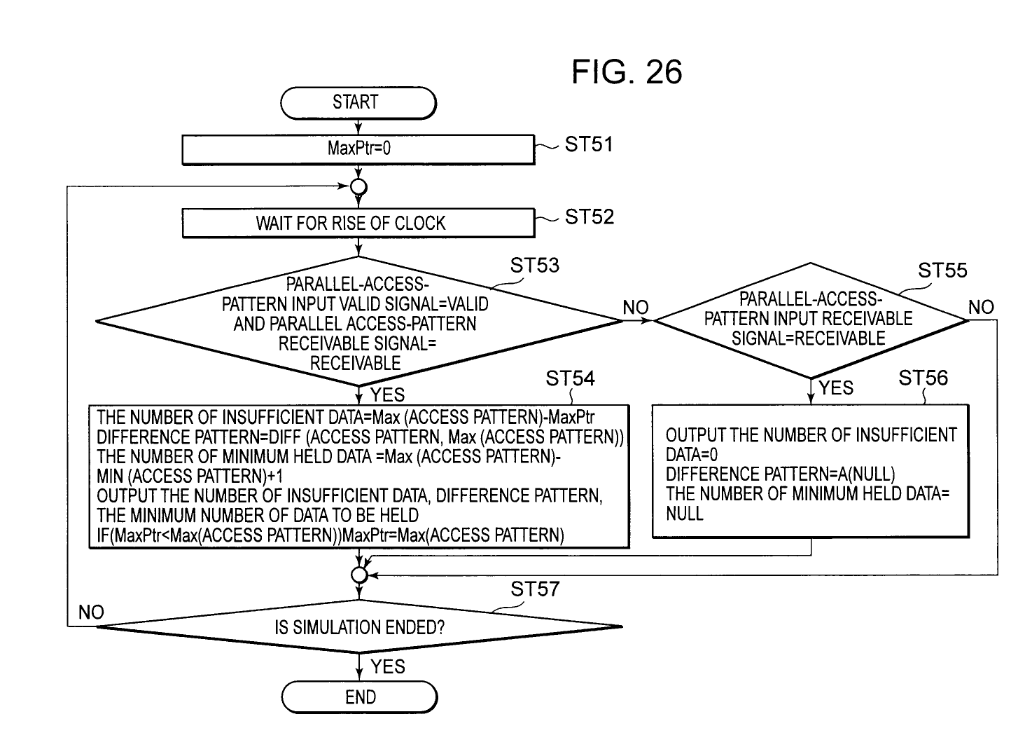

With reference to a flowchart in FIG. 26, a description is given of an operation in which a simulation is performed in the simulation device 14 using information stored in the test-circuit storing section 11, the circuit-information storing section 12, and the parallel-access-mechanism-configuration-output-circuit storing section 22, thereby generating the parallel-access-mechanism configuration information.

Thus, the access pattern input includes a value indicating which number of value and which number of value of the sequential data input are accessed.

Below, this is expressed as A(x1, x2) meaning that a value of an x1-th and that of an x2-th are accessed.

In FIG. 26, Max(access pattern) means that in the case where the access pattern is A(x1, x2), a maximum value out of the x1 and the x2 is returned.

Diff (access pattern, Max) means that in the case where the access pattern is A(x1, x2), A(x1−Max, x2−Max) is returned.

A(NULL) means that no access is made.

When the simulation of the circuit information of the parallel-access-mechanism-configuration output circuit stored in the parallel-access-mechanism-configuration-output-circuit storing section 22 is begun in the simulation device 14, MaxPtr indicating a number of a value inputted last, out of the sequential input data which have been accessed so far, is firstly initialized by 0 (ST51).

Subsequently, the parallel-access-mechanism-configuration output circuit waits for an update of the valid signal VLD. One example of a timing at which the valid signal VLD is updated is a rise or a fall of the clock signal CLK (ST52).

Thereafter, it is judged whether the parallel-access-pattern input valid signal PAPTN is valid and whether the parallel-access-pattern receivable signal PAPTNRP is receivable (ST53).

When a positive determination result is obtained at the step ST53, the number of insufficient data, a difference pattern, the minimum number of held data are outputted. Subsequently, MaxPtr=Max(access pattern) is set (ST54)

When a negative determination result is obtained at the step ST53, it is determined whether the parallel-access-pattern receivable signal PAPTNRSP is valid (ST55).

If a positive judgment result is obtained at the step ST54, the number of insufficient data=0; a difference pattern=A (NULL); and the minimum number of held data=NULL are outputted (ST56).

When the processes at the steps ST54 and ST56 are ended, and a negative judgment result is obtained at the step ST55, it is confirmed whether the simulation is ended (ST57). When the simulation is not ended, the process returns to a waiting of the update of the subsequent valid signal VLD.

FIG. 28 shows information supplied to the configuration-information storing section 15A.

When a simulation result by the simulation device 14 is stored in the configuration-information storing section 15A, the information stored in the configuration-information storing section 15A is used to generate a parallel access mechanism by the circuit generating device 16A.

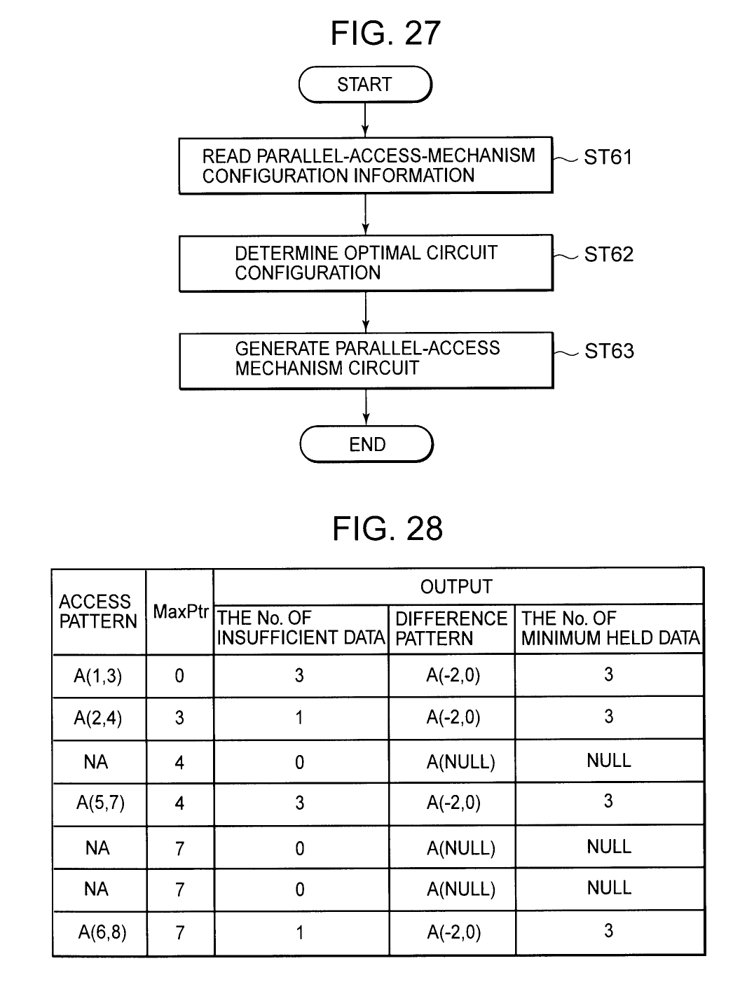

With reference to a flowchart in FIG. 27, a description is given of an operation for generating the parallel access mechanism by the circuit generating device 16A.

Firstly, the parallel-access-mechanism configuration information stored in the configuration-information storing section 15A is read (ST61). Subsequently, a circuit configuration most appropriate for the configuration information is determined (ST62). Finally, a parallel-access mechanism circuit 300 is generated based on the circuit configuration (ST63).

When the parallel-access mechanism circuit is generated by the circuit generating device 16A, the circuit information is stored in the circuit-information storing section 17A.

A more specific configuration example is next described.

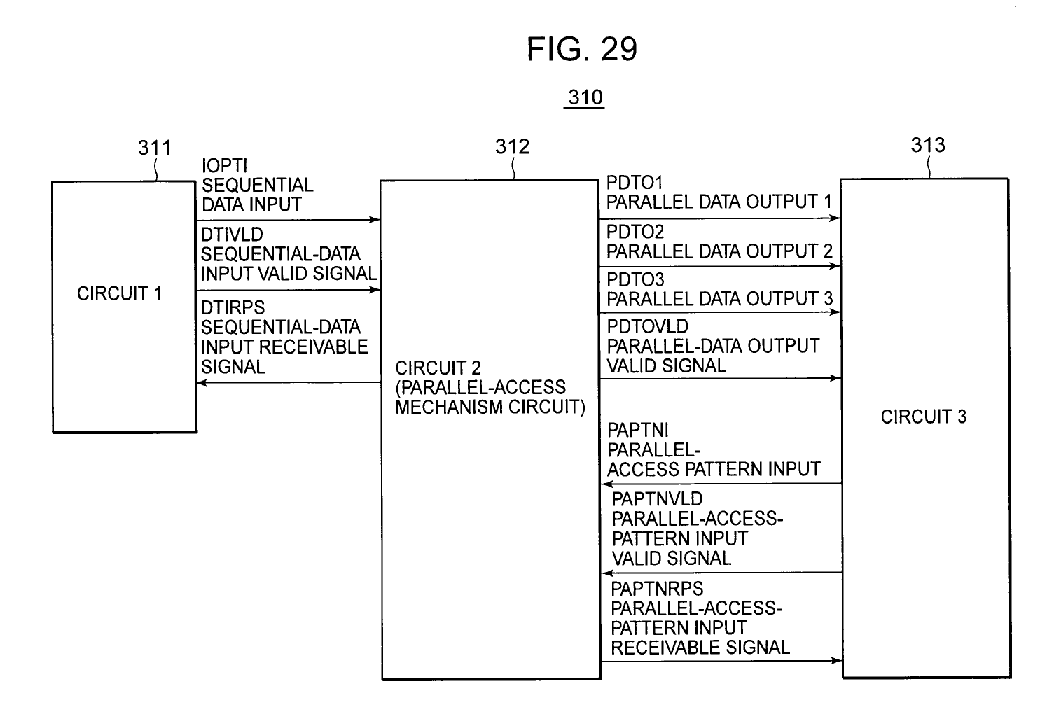

FIG. 29 is a diagram showing an example of an integrated circuit realized by the embodiment.

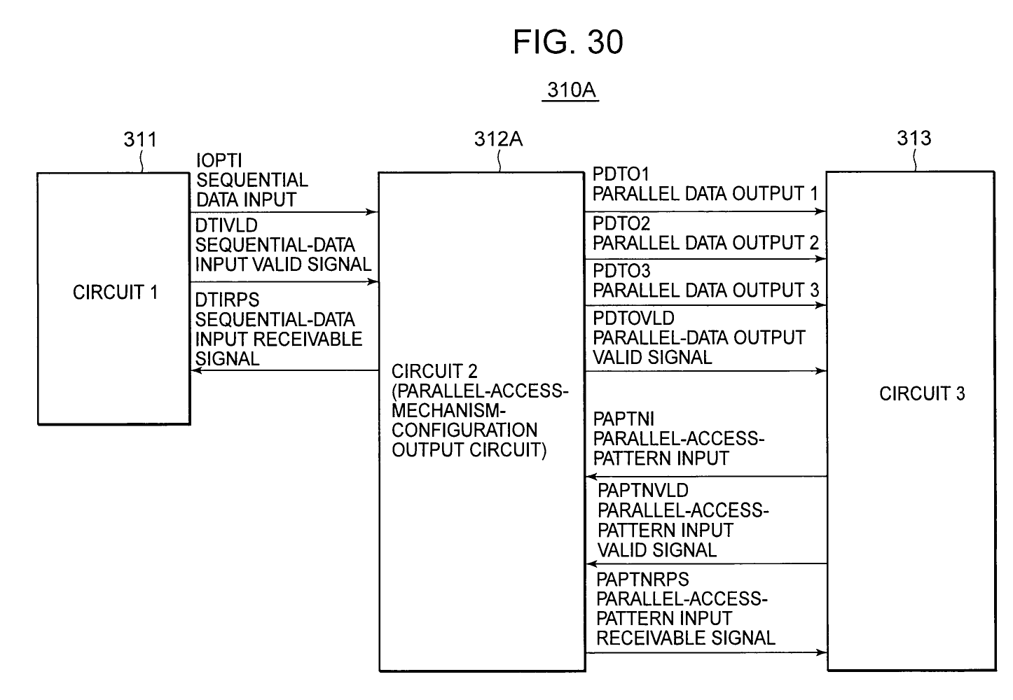

FIG. 30 is a diagram showing information inputted into the circuit generating device of a parallel process according to the embodiment.

As shown in FIG. 29 and FIG. 30, in an integrated circuit 310, first to third circuits 311 to 313 (circuit 1 to circuit 3) are connected in a cascade manner.

The second circuit 312 corresponds to the parallel-access mechanism circuit generated by the embodiment.

The first circuit 311 supplies not only the sequential data input valid signal DTIVLD but also the sequential data to the sequential data input IODTI of the second circuit 312. Further, the second circuit 312 supplies the sequential-data-input receivable signal DTIRPS to the first circuit.

The third circuit 313 supplies not only the parallel access pattern valid signal PAPTNVLD but also the parallel access pattern to the parallel-access pattern input PAPTNI of the second circuit 312. Further, the second circuit 312 supplies a parallel-access-pattern input receivable signal PAPTNRSP to the third circuit 313.

The second circuit 312 supplies the parallel data and the parallel-data-output valid signal PDTOVLD to the third circuit 313.

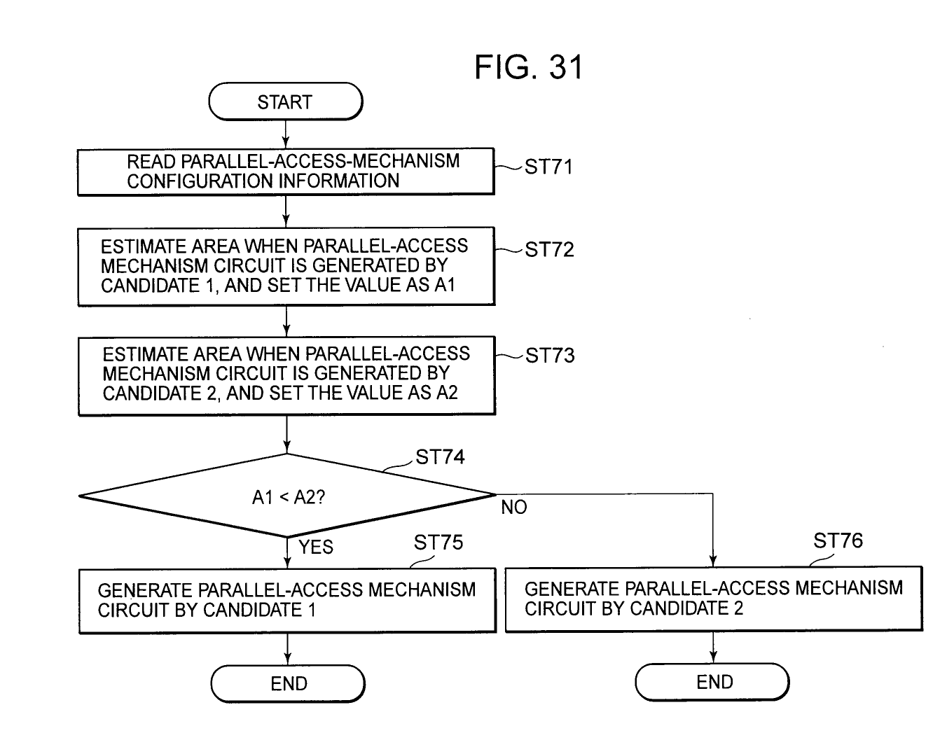

FIG. 31 is a flowchart showing an example of an operation for generating the parallel-access mechanism circuit performed in the circuit generating device 16A.

Firstly, the parallel-access-mechanism configuration information is read (ST71). Subsequently, based on the configuration information, the area in the case where the parallel-access mechanism circuit is generated by the configuration candidate 1 is estimated, and the value is set as A1 (ST72). Similarly, an estimated value of the area in the case where the parallel-access mechanism circuit is generated by the configuration candidate 2 is set as A2 (ST73).

A calculation of the estimate value is obtained by approximation expressions shown by the below-described expressions (3) and (4), for example. The approximation expression of the area estimate is determined per each architecture of the parallel-access mechanism circuit. The area estimates of all the prepared architectures are performed by the approximation expression.

### [Expression 3]

A1=area(storage element)*{(the minimum number of held data+maximum value of the number of insufficient data)+area(2→1 selector)*(N*(the minimum number of data to be held+maximum value of the number of insufficient data)−Σ(MMax−Max(M)+Min(M)−MMin)} (3)

In the expression (3), N denotes the number of outputs of the parallel data. Max (M) denotes a maximum value of the difference pattern of a parallel output port M, and Min(M) denotes a minimum value thereof. Further, MMax denotes a maximum Max (M) in all parallel output ports, and MMin denotes a minimum Min(M) thereof.

### [Expression 4]

A1=area(storage element)*(Max(S)*2)+area(2→1 selector)*(Max(Sa)*2+2) (4)

In the expression (4), M denotes a maximum value of the number of insufficient data; Sd denotes a total of the number of insufficient data in a period during which lasts from output in which the number of insufficient data is M to immediately prior to output in which the number thereof is subsequent M; Sa denotes a total of types of access patterns of each parallel data output, Max(Sd) denotes a maximum value of Sd; and Max(Sa) denotes a maximum value of Sa.

Finally, A1 and A2 are compared (ST24). When A1 is smaller, the candidate 1 is used (ST25) and when A2 is smaller, the candidate 2 is used to generate the parallel-access mechanism circuit (ST26).

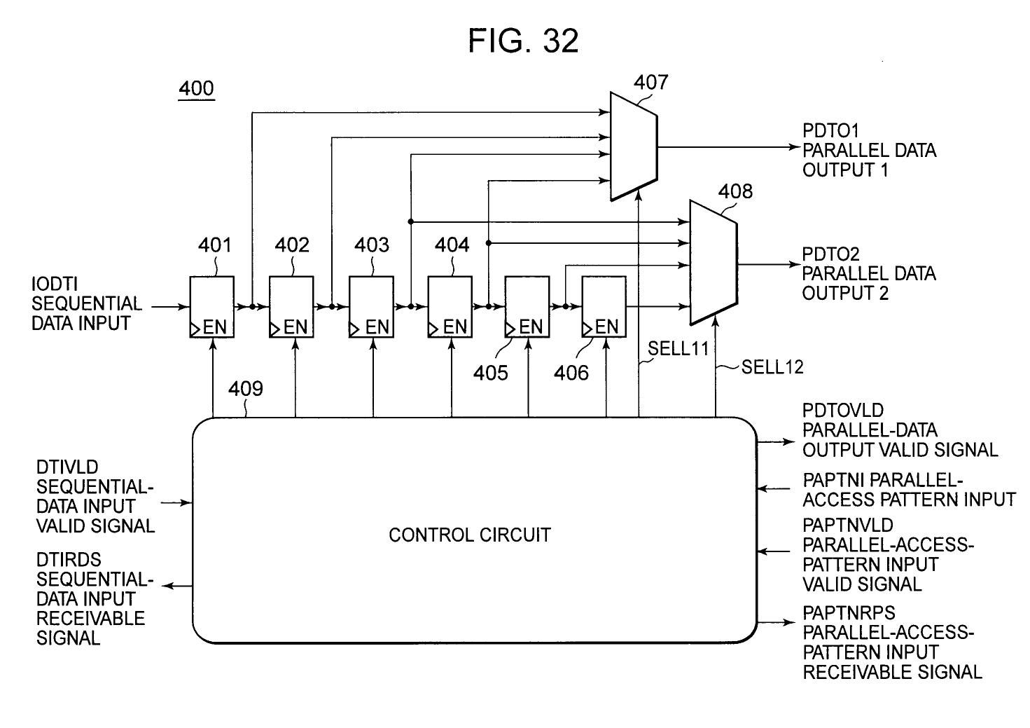

FIG. 32 is a diagram showing a first configuration example of a generated parallel-access mechanism circuit.

A synchronization mechanism circuit 400 includes latches with enable functions 401 to 406, selectors 407 and 408, and a control circuit 409.

The latches 401 to 406 receive the enable signal from the control circuit 409 and successively latch the sequential data.

The selector 407 selects any one of the outputs of the latches 401 to 404 in response to a first selection signal SEL11 by the control circuit 409, and outputs it as parallel data output PADTO1.

The selector 408 selects any one of the outputs of the latches 403 to 406 in response to a second selection signal SEL12 by the control circuit 409, and outputs it as parallel data output PADTO2.

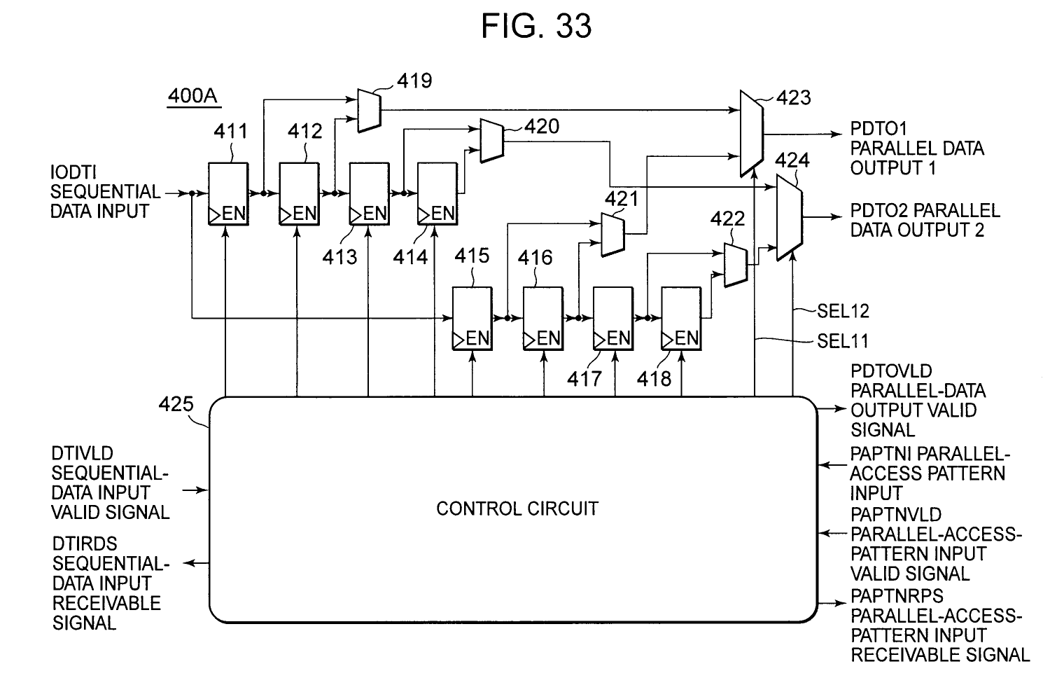

FIG. 33 is a diagram showing a second configuration example of the parallel-access mechanism circuit to be generated.

A synchronization mechanism circuit 400A includes latches with enable functions 411 to 418, selectors 419 to 424, and a control circuit 425.

The latches 411 to 414 receive the enable signal from the control circuit 425 and successively latch the sequential data.

Similarly, the latches 415 to 418 receive the enable signal from the control circuit 425 and successively latch the sequential data.

The selector 419 selects either one of the outputs of the latches 411 and 412 and outputs it to the selector 423, under the control of the control circuit 425.

The selector 420 selects any one of the outputs of the latches 411 and 414 and outputs it to the selector 424, under the control of the control circuit 425.

The selector 421 selects either one of the outputs of the latches 415 and 416 and outputs it to the selector 423, under the control of the control circuit 425.

The selector 422 selects either one of the outputs of the latches 417 and 418 and outputs it to the selector 424, under the control of the control circuit 425.

The selector 423 selects either one of the selection outputs of the selectors 419 and 421 in response to the first selection signal SEL11 by the control circuit 425, and outputs it as the parallel data output PADTO1.

The selector 424 selects either one of the selection outputs of the selectors 420 and 422 in response to the second selection signal SEL12 by the control circuit 425, and outputs it as the parallel data output PADTO2.

That is, according to the third embodiment, the synchronization mechanism or the parallel access mechanism of the value outputted from the circuits operative in parallel may be generated without inputting a specification of the synchronization mechanism or that of the parallel access mechanism. Further, even if a timing specification of the circuit is changed, it may be possible to easily re-generate the optimal synchronization mechanism or parallel access mechanism. As a result, a period of designing the synchronization mechanism and the parallel access mechanism may be greatly reduced.

Thus, a description is given of the generation of the synchronization mechanism or the parallel access mechanism. However, the configuration is not limited to that described above. A description is given below of another example of an architecture of the synchronization mechanism, an area estimate method, the number of modules, a content of the configuration information, a specification of the circuit, other application examples, et a1.

### <Another Architecture of the Synchronization Mechanism Circuit>

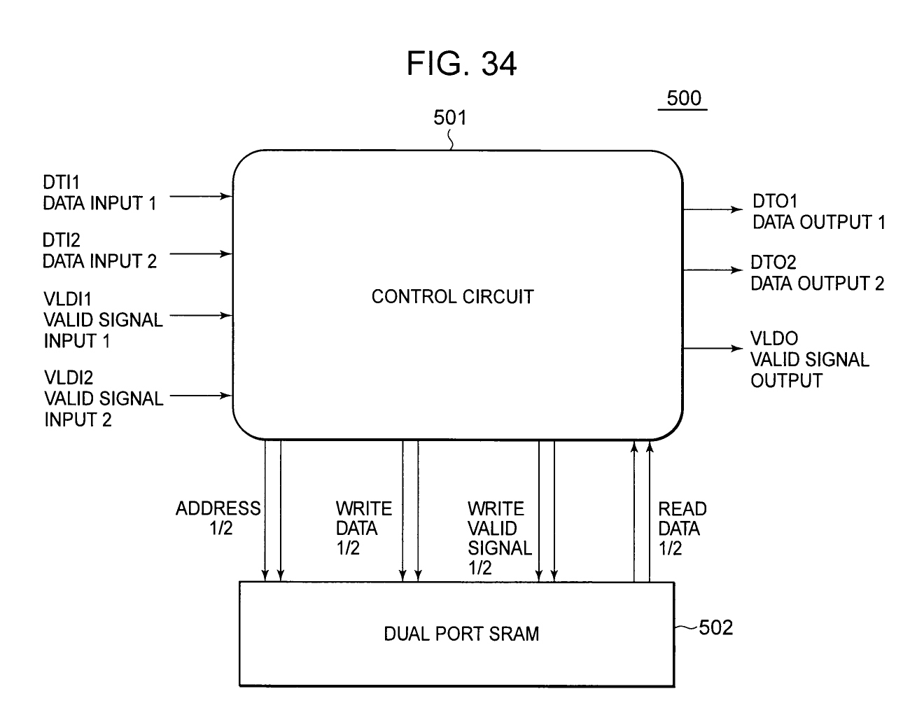

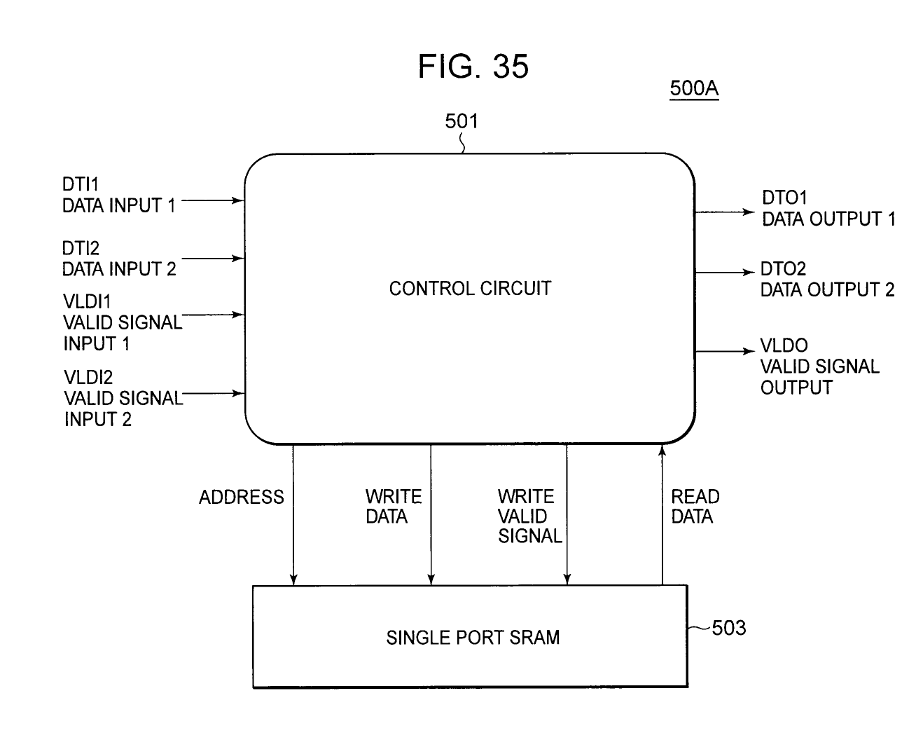

In the embodiments, a flip flop-based (latch) synchronization-mechanism circuit architecture is provided. However, as shown in FIG. 34 and FIG. 35, for example, embodiments of the present invention may be similarly applied to an SRAM-based architecture.

A circuit 500 in FIG. 34 is configured by a control circuit 501 and a dual-port SRAM 502.

A circuit 500A in FIG. 35 is configured by the control circuit 501 and a single-port SRAM 503.

### <Area Estimate Method of the Synchronization Mechanism Circuit>

In the embodiments, an area-estimate approximation expression is used. However, all-pattern-synchronization-mechanism circuit information is generated, and all the circuits are logically synthesized or laid out, whereby the resultant area may be used as an estimated value.

Alternatively, regarding the method in which the approximation expressions used in the embodiments are employed, a more precise approximation expression including an area of the control circuit may be used.

### <Selection Method of the Synchronization Mechanism Circuit Architecture>

In the embodiments, the area is estimated by the approximation expression, and the results are compared for selection. However, such a selection may be performed by using a threshold value. For example, in the case where values of the counter [1] and the counter [2] are equal to or more than a threshold value, the SRAM-based architecture is selected, and in the case where the values thereof are equal to or less than the threshold value, the flip flop-based architecture is selected, for example.

### <The Number of Modules>

In the embodiments, an example of generating the synchronization mechanism circuit by the circuits 1 to 6 and the synchronization-mechanism-configuration output circuit (the circuit 7) in FIG. 10 is shown. However, the number of circuits other than the synchronization-mechanism-configuration output circuit may be only 1 or 6 or more. Further, a plurality of synchronization-mechanism-configuration output circuits may be placed to simultaneously generate a plurality of synchronization mechanism circuits.

### <Regarding a Content of the Synchronization-Mechanism Configuration Information>

In the embodiments, the four values, that is, the counter[1], the counter[2], the time difference TDF1, and the time difference TDF2, are outputted, as shown in FIG. 11. It may be possible that only the counter[1] and the counter[2] are outputted, or that only the time difference TDF1 and the time difference TDF2 are outputted.

Further, configuration information of a type which is not described in the embodiments may be possible such as (output time), (a time at which the data outputted from the data output 1 is inputted), and (a time at which the data outputted from the data output 2 is inputted).

### <Regarding the Specification of the Synchronization Mechanism Circuit>

In the embodiments, the specification of the synchronization mechanism circuit is employed where the output is made immediately at an outputtable state, but the specification thereof may define such that the output is made at a time subsequent to the outputtable state.

Another specification may include specification where in addition to a serial-to-parallel conversion, when the two data are accumulated, one data is integrally outputted.

### <Regarding the Synchronization-Mechanism Generating Device>

The embodiments are adapted such that the synchronization mechanism circuit is generated by only the information from the synchronization mechanism configuration device. However, it addition thereto, a constraint condition may be externally applied.

### Regarding Other Application Examples

### (1) Merging a Difference in Latency Before and after the Behavioral Synthesis and Generation of the Synchronization Mechanism Circuit

Before the behavioral synthesis, the design is made by a model without a computation delay, and when the behavioral synthesis is performed, however, it becomes a model in which a delay of the actual device is considered. Therefore, when it is necessary to synchronize outputs of a plurality of modules, it is necessary to synchronize at different timings before and after the behavioral synthesis.

The circuit desired to be designed is a circuit capable of synchronizing at a timing after the behavioral synthesis, and thus, before the behavioral synthesis, a actually mountable synchronization mechanism circuit may not be necessary.

Therefore, firstly, before the behavioral synthesis, artificially ideal behavior of the synchronization mechanism owned by the synchronization-mechanism-configuration output circuit is utilized to perform the simulation.

Subsequently, the behavioral synthesis is performed such that all the circuits other than the synchronization mechanism circuit are operated at a correct timing. Then, once again, the synchronization-mechanism-configuration output circuit is utilized to performed the simulation, thereby obtaining the synchronization-mechanism configuration information. Out of the information, the synchronization mechanism circuit is generated.

### (2) Application in the Case where a Range is Greatly Expanded

A technique in which a profiling is performed by the simulation, and a result obtained therefrom is used to generate the circuit has other applications described below:

Generation of a Cache Memory;

A memory access pattern and a desired cache hit rate are used to generate the appropriate cache memory.

Generation of a Bus Matrix;

Based on a communication amount between the modules, the appropriate bus matrix is generated (a wide range bus for a portion with a large communication amount, and a small area bus for a portion with a small communication amount).

Generation of DMA Including FIFO;

The number of steps of FIFO is determined from a congestion degree of a bus and a performance of a later-step block, and thereby DMA including the FIFO is generated;

Extraction of a Performance Constraint at the Time of the Behavioral Synthesis

A performance constraint necessary for processing without causing a bottleneck is extracted from an input data flow amount.

The embodiments of the present invention are not limited to the embodiments, and it is possible for a person skilled in the art to apply various modifications if the gist of the present invention is not changed.

The method described above in detail may be configured as a program according to the above-described procedures and elements executed by a computer such as a CPU or the like.

Further, such a program may be configured to be accessed by recording media, such as a semiconductor memory, a magnetic disk, an optical disk, a floppy (registered trademark) disk, and a computer to which the recording medium is set, whereby the program is executed.

According to embodiments of the present invention, it becomes possible to generate an adjusting mechanism without inputting a specification, and to easily re-generate the adjusting mechanism, such as an optimal synchronization mechanism, parallel access mechanism or the like even when a timing specification of a circuit changes, thereby permitting shortening of a period of designing the adjusting mechanism, such as a synchronization mechanism, a parallel access mechanism and the like.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-085010 filed in the Japanese Patent Office on Mar. 28, 2007, the entire content of which being incorporated herein by reference.

What is claimed is:

1. An integrated-circuit generating device for generating an integrated circuit including an adjusting mechanism for adjusting timings of values sequentially outputted from circuits operating in parallel, comprising:
a test-circuit storing section for storing test circuit information for validating the integrated circuit;
a circuit-information storing section for storing circuit information;
a configuration-information-output-circuit storing section for storing operation information of a circuit for compiling configuration information of the adjusting mechanism while the configuration information is generated;
a configuration-information generating section for generating and compiling the configuration information of the adjusting mechanism by using the circuit information of the test circuit, the circuit information of the integrated circuit, and the operation information of the circuit, each of which stored in the test-circuit storing section, the circuit-information storing section, and the configuration-information-output-circuit storing section, and
a circuit generating device for generating the circuit information of an optimal adjusting mechanism based on the adjusting-mechanism configuration information by the configuration-information generating section.

2. The integrated-circuit generating device according to claim 1, wherein;
the configuration-information output circuit stored in the configuration-information-output-circuit storing section includes a counter corresponding to a valid signal indicating that a valid value or an invalid value is set to data to be processed; and
the configuration-information generating section sets a counter value responding to a state of the valid signal, and generates and compiles the configuration information.

3. The integrated-circuit generating device according to claim 1, wherein;
the circuit generating device estimates an area of each circuit in a case where a plurality of adjusting mechanism circuits are generated, based on the configuration information generated by the configuration-information generating section, and generates a circuit having a small area, out of the estimated areas.

4. The integrated-circuit generating device according to claim 3, wherein;
the circuit generating device estimates the area based on an approximation expression determined by each architecture of the adjusting mechanism circuit.

5. The integrated-circuit generating device according to any one of claims 1 to 4, comprising:
a configuration-information storing section for storing the adjusting-mechanism configuration information generated by the configuration-information generating section, wherein;
the circuit generating device reads out the configuration information stored in the configuration-information storing section to generate the circuit information.

6. The integrated-circuit generating device according to any one of claims 1 to 5, wherein;
the adjusting mechanism includes a synchronization mechanism for making timings coincident with values sequentially outputted from a plurality of circuits operating in parallel.

7. The integrated-circuit generating device according to any one of claims 1 to 5, wherein;
the adjusting mechanism includes a parallel access mechanism for adjusting timing of parallel access.

8. An integrated-circuit generating method for generating an integrated circuit including an adjusting mechanism for adjusting timings of values sequentially outputted from circuits operating in parallel, comprising:
a configuration-information generating step for generating and compiling configuration information of the adjusting mechanism by using test circuit information for validating the integrated circuit, circuit information of the integrated circuit, and operation information of a configuration-information output circuit; and
a circuit generating step for generating the circuit information of an optimal adjusting mechanism based on the adjusting-mechanism configuration information by the configuration-information generating step.

9. The integrated-circuit generating method according to claim 8, wherein;
the configuration-information output circuit is provided with a counter corresponding to a valid signal indicating that a valid value or an invalid value is set to data to be processed; and
in the configuration-information generating step, a counter value responsive to a state of the valid signal is set, and the configuration information is generated and compiled.

10. The integrated-circuit generating method according to claim 8, wherein;
in the circuit generating step, an area of each circuit in a case where a plurality of adjusting mechanism circuits are generated is estimated based on the configuration information generated by the configuration-information generating section, and generates a circuit having a small area, out of the estimated areas.

11. A program for causing a computer to execute a process for generating an integrated-circuit including an adjusting mechanism for adjusting timings of values sequentially outputted from circuits operating in parallel, the process comprising:
a configuration-information generating process for generating and compiling configuration information of the adjusting mechanism by using test circuit information for validating the integrated circuit, circuit information of the integrated circuit, and operation information of a configuration-information output circuit; and
a circuit generating process for generating the circuit information of an optimal adjusting mechanism based on the adjusting-mechanism configuration information by the configuration-information generating step.
